(19) United States
(12) Patent Application Publication
(10) Pub. No.: US 2025/0246172 A1
(43) Pub. Date: Jul. 31, 2025

(54) KEYBOARD DEVICE AND DETECTION METHOD FOR KEY PRESS INFORMATION

(71) Applicant: Roland Corporation, Shizuoka (JP)

(72) Inventors: Yukihide Takata, Shizuoka (JP); Shiro Uno, Shizuoka (JP)

(73) Assignee: Roland Corporation, Shizuoka (JP)

(21) Appl. No.: 18/854,973

(22) PCT Filed: Aug. 30, 2022
(86) PCT No.: PCT/JP2022/032673

§ 371 Date: Oct. 8, 2024

(51) Int. Cl. G10H 1/34

(52) U.S. Cl. CPC G10H 1/346; G10H 2220/221; G10H 2220/275

(57) ABSTRACT

A detected part is provided at a displacement member acting in conjunction with a white key or a hammer. Since the displacement member is capable of being formed smaller compared to the white key and the hammer, dimensional errors are less likely to occur in each displacement member. Further, since the displacement member is configured to be pivotally supported on a relatively small holder mounted to a substrate rather than on a chassis, mounting errors of each displacement member are also less likely to occur. By reducing the dimensional errors and the mounting errors, a clearance between a coil and the detected part is easily set to a dimension according to a design value at each key. Thus, key press information of each key can be detected with high accuracy.

### CROSS-REFERENCE TO RELATED APPLICATION

This application is a 371 application of the International PCT application serial no. PCT/JP2022/032673, filed on Aug. 30, 2022. The entirety of the above-mentioned patent application is hereby incorporated by reference herein and made a part of this specification.

### TECHNICAL FIELD

The present invention relates to a keyboard device and a detection method for key press information, and particularly, to a keyboard device and a detection method for key press information capable of detecting key press information with high accuracy.

### RELATED ART

A technique for detecting a depth, a speed, etc. of key press (hereinafter referred to as “key press information”) using a non-contact sensor is known. For example, Patent Document 1 describes a technique in which a coil 57 (sensor) generating a magnetic field is formed on a substrate 56, and a metal plate 55 (detected part) opposed to the coil 57 is fixed to a key 41. According to this technique, since a current (magnetic field) flowing through the coil 57 changes due to relative displacement of the metal plate 55 with respect to the coil 57 during key press, key press information can be detected based on changes in the current.

To detect key press information with high accuracy using this type of non-contact sensor, it is required to set a clearance between the sensor and the detected part to a dimension according to a design value at each key. However, with a configuration in which the detected part is provided at the key as in the related art described above, dimensional errors of each key itself, mounting errors of each key, etc. accumulate, and the clearance between the sensor and the detected part at each key is likely to deviate from the design value. Thus, there is a problem that key press information cannot be detected with high accuracy.

The present invention has been made to solve the aforementioned problem, and an objective thereof is to provide a keyboard device and a detection method for key press information capable of detecting key press information with high accuracy.

### RELATED ART DOCUMENTS

### Patent Documents

Patent Document 1: Japanese Patent Application Laid-Open No. H03-048295 (e.g., lines 7 to 18 of upper left column on page 9, FIG. 29 of Patent Document 1)

### SUMMARY OF INVENTION

To achieve this objective, a keyboard device of the present invention includes: a first support member; a plurality of keys swingably supported on the first support member; a displacement member that displaces in conjunction with swinging of the key or rotation of a hammer accompanying the swinging of the key; a sensor opposed to a detected part of the displacement member to detect displacement of the displacement member; a substrate on which the sensor is provided; and a second support member mounted to the substrate and supporting the displacement member displaceably.

A detection method for key press information of the present invention is a detection method for key press information in a keyboard device. The keyboard device includes: a first support member; a plurality of keys swingably supported on the first support member; a displacement member that displaces in conjunction with swinging of the key or rotation of a hammer accompanying the swinging of the key; a sensor opposed to a detected part of the displacement member to detect displacement of the displacement member; a substrate on which the sensor is provided; and a second support member mounted to the substrate and supporting the displacement member displaceably. The key press information of the key is detected by causing the detected part to relatively displace with respect to the sensor by the displacement of the displacement member.

### BRIEF DESCRIPTION OF DRAWINGS

FIG. 1 is cross-sectional view of a keyboard device of a first embodiment.

FIG. 2A is a partially enlarged cross-sectional view of the keyboard device at a portion IIa in FIG. 1, and FIG. 2B is a partially enlarged cross-sectional view of the keyboard device taken along a line IIb-IIb in FIG. 2A.

FIG. 3A is a partially enlarged cross-sectional view of the keyboard device showing a state in which a white key is pressed from the state in FIG. 2A, and FIG. 3B is a partially enlarged cross-sectional view of the keyboard device showing a state in which the white key is pressed to a terminal position from the state in FIG. 3A.

FIG. 4A is a graph showing a relationship between a stroke amount of a key and a sensor output, FIG. 4B is a partially enlarged cross-sectional view of the keyboard device showing an enlarged view of a portion IVb in FIG. 3A, and FIG. 4C is a partially enlarged cross-sectional view of the keyboard device taken along a line IVc-IVc in FIG. 4B.

FIG. 5A is a schematic view of a magnetic field (magnetic field lines) in the case where a thin detected part is formed only on a bottom surface of a displacement member, and FIG. 5B is a schematic view of a magnetic field (magnetic field lines) in the case where the detected part is formed on a bottom surface and a front surface of the displacement member.

FIG. 6 is an exploded perspective view of the keyboard device.

FIG. 7A is a partially enlarged front view of a holder, FIG. 7B is a partially enlarged top view of the holder as viewed in a direction of an arrow VIIb in FIG. 7A, and FIG. 7C is a front view of the holder showing the holder in a bent state.

FIG. 8A is a perspective view showing sliding of a shaft part of the holder along a guide groove, and FIG. 8B is a perspective view showing a state in which the holder mounted with the displacement member is fixed to a substrate 9.

FIG. 9A is a side view of a displacement member showing a first modification example, and FIG. 9B is a graph showing a relationship between a stroke amount of key press and a sensor output in the case of using the displacement member of the first modification example.

FIG. 10A is a side view of a displacement member showing a second modification example, and FIG. 10B is a graph showing a relationship between a stroke amount of key press and a sensor output in the case of using the displacement member of the second modification example.

FIG. 11 is a cross-sectional view of a keyboard device of a second embodiment.

FIG. 12 is an exploded perspective view of the keyboard device.

FIG. 13A is a partially enlarged cross-sectional view of the keyboard device showing fitting of a shaft part of a holder into an insertion hole of a white key, and FIG. 13B is a partially enlarged cross-sectional view of the keyboard device showing a state in which the shaft part of the holder is fitted into the insertion hole of the white key.

FIG. 14A is a partially enlarged cross-sectional view of the keyboard device showing an enlarged view of a portion XIVa in FIG. 11, and FIG. 14B is a partially enlarged cross-sectional view of the keyboard device showing a state in which the white key is pressed to a terminal position from the state in FIG. 14A.

FIG. 15A is a partially enlarged cross-sectional view of a keyboard device of a third embodiment, and FIG. 15B is a partially enlarged cross-sectional view of the keyboard device taken along a line XVb-XVb in FIG. 15A.

FIG. 16A is a partially enlarged cross-sectional view of the keyboard device showing a state in which the white key is pressed from the state in FIG. 15A, and FIG. 16B is a partially enlarged cross-sectional view of the keyboard device showing a state in which the white key is pressed to a terminal position from the state in FIG. 16A.

### DESCRIPTION OF EMBODIMENTS

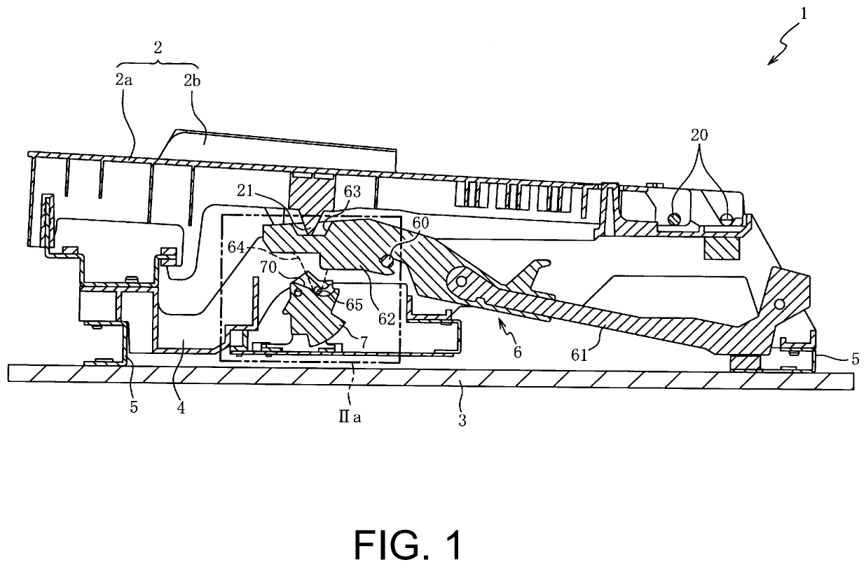

Hereinafter, preferred embodiments will be described with reference to the accompanying drawings. First, referring to FIG. 1, an overall configuration of a keyboard device 1 of a first embodiment will be described. FIG. 1 is a cross-sectional view of the keyboard device 1 in the first embodiment.

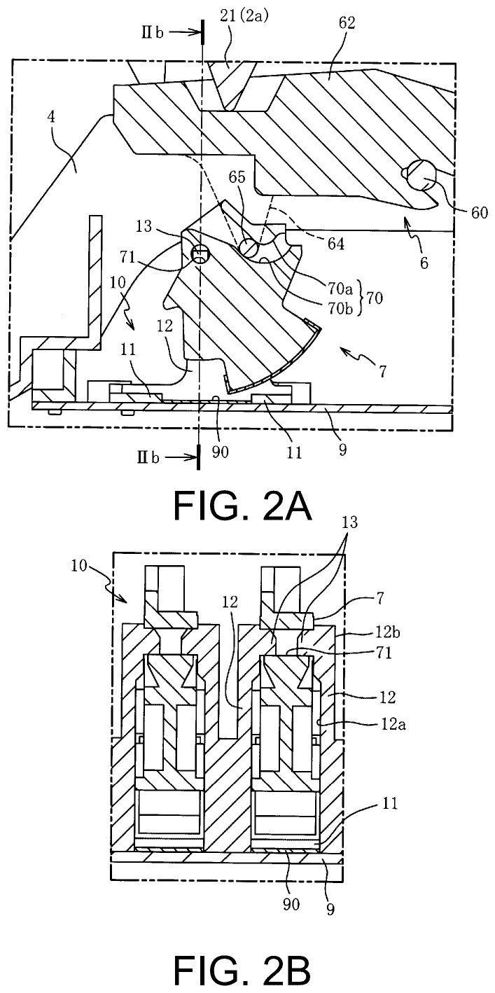

FIG. 1 shows a cross-section cut in a plane orthogonal to a scale direction (arrangement direction of a plurality of keys 2) of the keyboard device 1. Further, in the following description, a close side (left side in FIG. 1) viewed from a player will be referred to as a front side of the keyboard device 1, and an opposite side (right side in FIG. 1) thereof will be referred to as a rear side. An arrangement direction (a direction perpendicular to the paper surface in FIG. 1) of the plurality of keys 2 will be referred as a scale direction. Further, in FIG. 1, a protruding part 64 of a hammer 6 is shown in a broken line (which similarly applies to FIG. 2A and subsequent figures).

As shown in FIG. 1, the keyboard device 1 is a keyboard instrument (electronic piano) that includes a plurality (88 in this embodiment) of keys 2. The keys 2 are composed of a plurality (52 in this embodiment) of white keys 2a for playing natural notes and a plurality (36 in this embodiment) black keys 2b for playing derived notes. The plurality of white keys 2a and black keys 2b are arranged in the scale direction (the direction perpendicular to the paper surface in FIG. 1).

The keyboard device 1 includes a bottom plate 3 for supporting the white keys 2a and the black keys 2b. The bottom plate 3 is formed of a synthetic resin, a steel plate, etc. into a flat plate shape extending in the scale direction, and a chassis 4 made of resin is supported on an upper surface of the bottom plate 3. Both front and rear end parts of the chassis 4 are fixed to the bottom plate 3 via channel materials 5.

A rotation shaft 20 of the keys 2 is provided on an upper surface on a rear end side (right side in FIG. 1) of the chassis 4, and a rear end portion of each key 2 is rotatably (swingably) supported on the chassis 4 by the rotation shaft 20. A hammer 6 and a displacement member 7 that act in conjunction with the rotation of the key 2 are provided below the key 2.

Hereinafter, a detailed configuration of the white key 2a will be described, and such a configuration is substantially the same for the black key 2b. Thus, functions and effects of the configuration of the white key 2a described below are similarly achieved in the black key 2b.

At a substantially central portion of the chassis 4 in a front-rear direction, the hammer 6 is supported rotatably around a rotation shaft 60 that extends along the scale direction. The hammer 6 includes a mass part 61 (mass body) for imparting a key press touch during key press of the white key 2a, and the mass part 61 is positioned on the rear side (right side in FIG. 1) of the rotation shaft 60.

A portion of the hammer 6 on the front side of the rotation shaft 60 is configured as a pressing part 62 for pushing the displacement member 7 during key press of the white key 2a. A receiving part 63 that is recessed downward is formed on an upper surface of the pressing part 62, and a protruding part 21 of the white key 2a is inserted into the receiving part 63.

The protruding part 21 protrudes downward from a lower surface of the white key 2a at a substantially central portion in the front-rear direction. A bottom surface of the receiving part 63 is configured as a sliding surface against which a tip (lower end) of the protruding part 21 slides forward and backward. During key press of the white key 2a, while the protruding part 21 of the white key 2a slides along the bottom surface of the receiving part 63, the hammer 6 rotates around the rotation shaft 60 (counterclockwise in FIG. 1) due to downward pushing of the pressing part 62 by the protruding part 21.

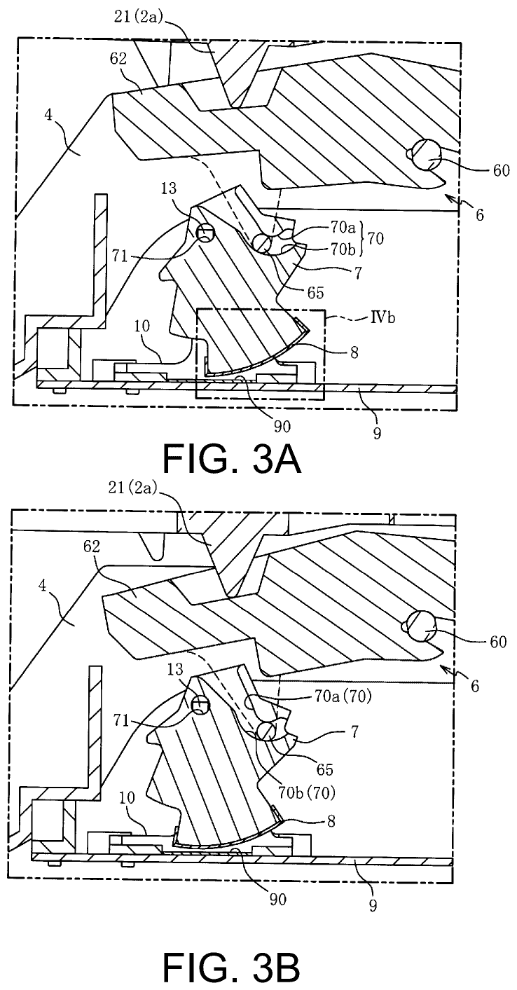

Due to rotation of the hammer 6, a guide pin 65 formed at the protruding part 64 of the hammer 6 slides along a groove 70 of the displacement member 7, which thus causes the displacement member 7 to rotate. Details of this structure causing the displacement member 7 to rotate will be described with reference to FIG. 2A to FIG. 3B.

FIG. 2A is a partially enlarged cross-sectional view of the keyboard device 1 at a portion IIa in FIG. 1, and FIG. 2B is a partially enlarged cross-sectional view of the keyboard device 1 taken along a line IIb-IIb in FIG. 2A. FIG. 3A is a partially enlarged cross-sectional view of the keyboard device 1 showing a state in which the white key 2a is pressed from the state in FIG. 2A, and FIG. 3B is a partially enlarged cross-sectional view of the keyboard device 1 showing a state in which the white key 2a is pressed to a terminal position from the state in FIG. 3A.

A detected part 8 is plated on the displacement member 7, and a coil 90 is printed on a substrate 9. However, in FIG. 2A to FIG. 3B, cross-sections of the detected part 8 and the coil 90 are schematically illustrated (which similarly applies to subsequent figures).

As shown in FIG. 2A, the protruding part 64 protrudes downward from a lower surface of the pressing part 62, and the guide pin 65 protrudes in the scale direction from a lateral surface (a surface facing the direction perpendicular to the paper surface in FIG. 2A) of the protruding part 64. The protruding part 64 and the guide pin 65 are integrally formed with the pressing part 62 of the hammer 6.

The guide pin 65 slidably engages with the groove 70 formed at the displacement member 7, and the displacement member 7 is rotatably supported at a holder 10 fixed to the substrate 9. The substrate 9 is fixed to the chassis 4 on the lower side of the hammer 6, and the coil 90 for detecting rotation of the displacement member 7 is printed on the substrate 9.

The holder 10 includes a mounted part 11 mounted to an upper surface of the substrate 9, a wall part 12 rising upward from the mounted part 11, and a shaft part 13 in a substantially cylindrical shape formed on an upper end side of the wall part 12. A plurality of wall parts 12 are arranged at the mounted part 11 extending in the scale direction (left-right direction in FIG. 2B), and the displacement member 7 is rotatably supported between the plurality of opposing wall parts 12.

In the following description, of lateral surfaces (surfaces facing the scale direction) of the wall part 12, a lateral surface that sandwiches the displacement member 7 will be described as an inner surface 12a of the wall part 12, and a lateral surface opposite to the inner surface 12a will be described as an outer surface 12b. The shaft part 13 protrudes in the scale direction from the inner surface 12a of the wall part 12, and the shaft part 13 is inserted into an insertion hole 71 that penetrates the displacement member 7 in the scale direction.

The rotation of the displacement member 7 with respect to the shaft part 13 is performed by the sliding between the guide pin 65 of the hammer 6 and the groove 70 formed at the displacement member 7 described above. The groove 70 extends from an upper end portion of the displacement member 7 toward the rear side (right side in FIG. 2A). Upper and lower surfaces of the groove 70 against which the guide pin 65 slides during key press (key release) of the white key 2a are defined and described as an upper sliding surface 70a and a lower sliding surface 70b.

The guide pin 65 of the hammer 6 engages with each of the sliding surfaces 70a and 70b of the groove 70 in a region between the rotation shaft 60 of the hammer 6 and the shaft part 13 (rotation shaft of the displacement member 7) of the holder 10. Further, in an initial state before the white key 2a is pressed, the lower sliding surface 70b of the groove 70 extends to intersect with a displacement trajectory of the guide pin 65 around the rotation shaft 60.

Thus, as shown in FIG. 3A and FIG. 3B, when the pressing part 62 of the hammer 6 is pushed downward by the protruding part 21 of the white key 2a upon key press, and the guide pin 65 rotates around the rotation shaft 60 (counterclockwise in FIG. 3A and FIG. 3B), the lower sliding surface 70b is pushed downward by the guide pin 65. Accordingly, the displacement member 7 rotates around the shaft parts 13 (clockwise in FIG. 3A and FIG. 3B).

Along with the rotation of the displacement member 7, the detected part 8 provided on the bottom surface of the displacement member 7 displaces relatively with respect to the coil 90 on the substrate 9. In other words, as a stroke amount of the white key 2a increases from the state before key press, an entry amount of the detected part 8 into a region opposed to the coil 90 (hereinafter referred to as a “detection region”) increases. The entry amount of the detected part 8 refers to a size of an area where the detected part 8 and the coil 90 are opposed to each other in a thickness direction of the substrate 9.

On the other hand, in the case where the white key 2a is released after being pressed (hereinafter referred to as “during key release of white key 2a”), the guide pin 65 rotates around the rotation shaft 60 (clockwise in FIG. 3A and FIG. 3B) to return to the initial state due to the weight of the mass part 61 (refer to FIG. 1) of the hammer 6. Due to this rotation of the guide pin 65, the upper sliding surface 70a is pushed upward by the guide pin 65, which thus causes the displacement member 7 to rotate around the shaft parts 13 (counterclockwise in FIG. 3A and FIG. 3B). At this time, the entry amount of the detected part 8 with respect to the detection region decreases.

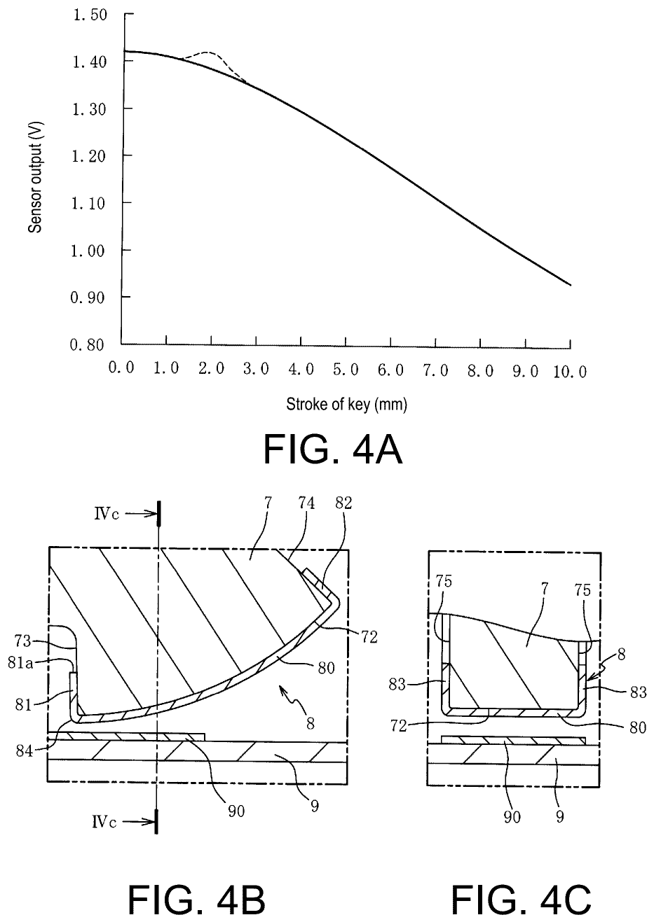

Since the detected part 8 is formed using a non-magnetic metal (e.g., copper), with a current passed through the coil 90 to generate a magnetic field, an inductance of the coil 90 decreases upon increasing the entry amount of the detected part 8 into the detection region, and the inductance of the coil 90 increases upon decreasing the entry amount of the detected part 8 into the detection region. Based on such increase and decrease in the inductance of the coil 90, a sensor output value (V) changes (refer to FIG. 4A). Key press information (note information) is detected based on such increase and decrease in the sensor output value.

The sensor output will be described with reference to FIG. 3A to FIG. 4C. FIG. 4A is a graph showing a relationship between a stroke amount of the key 2 and a sensor output, where the vertical axis represents a magnitude (V) of the sensor output, and the horizontal axis represents the stroke amount (mm) of the key 2. FIG. 4B is a partially enlarged cross-sectional view of the keyboard device 1 showing an enlarged view of a portion IVb in FIG. 3A, and FIG. 4C is a partially enlarged cross-sectional view of the keyboard device 1 taken along a line IVc-IVc in FIG. 4B. In FIG. 4B and FIG. 4C, illustrations of some configurations (e.g., the holder 10 shown in FIG. 3A and FIG. 3B) are omitted, and only main parts of the keyboard device 1 are illustrated.

As shown in FIG. 4A, in this embodiment, the sensor output is configured to decrease almost proportionally as the white key 2a is pressed. This is because, as shown in FIG. 3A and FIG. 3B, the lower sliding surface 70b of the groove 70 is formed into an arc shape that is convex downward, and an almost proportional relationship is formed between the stroke amount of the white key 2a (rotation amount of the guide pin 65 around the rotation shaft 60) during key press and the rotation amount of the displacement member 7 around the shaft parts 13.

Further, since the upper sliding surface 70a also has a shape corresponding to the lower sliding surface 70b (an interval between the sliding surfaces 70a and 70b is constant), during key release of the white key 2a, the sensor output increases almost proportionally to the decrease in the stroke of the white key 2a. Based on such increase and decrease in the sensor output, key press information such as a depth and a speed of key press of the white key 2a is detected. To detect the key press information with high accuracy, it is required to set a clearance between the detected part 8 and the coil 90 to a dimension according to a design value at each key 2.

In a related art that detects key press information using such a non-contact sensor, the detected part would be provided at a rotating member such as the key 2, the hammer 6, etc. (e.g., Japanese Patent Application Laid-Open No. H03-048295). In such a configuration, variations are likely to occur in the clearance between the coil 90 and the detected part 8.

The first reason for such variations to occur lies in that dimensions of the key 2 and the hammer 6 themselves are large (long in a front-rear direction dimension), so dimensional errors are likely to occur at each key 2 and each hammer 6. Further, the second reason lies in that a dimension of the chassis 4 supporting the key 2 and the hammer 6 is also large, so mounting (assembly) errors are likely to occur in the key 2 and the hammer 6.

In contrast, in this embodiment, as shown in FIG. 3A and FIG. 3B, the detected part 8 is configured to be provided at the displacement member 7 which acts in conjunction with the white key 2a and the hammer 6, rather than at the white key 2a and the hammer 6. Since the displacement member 7 may be formed to be smaller compared to the white key 2a and the hammer 6, dimensional errors are less likely to occur at each displacement member 7. Further, since the displacement member 7 is configured to be pivotally supported on a relatively small holder 10 directly mounted to the substrate 9, rather than on the chassis 4, mounting errors of each displacement member 7 are also less likely to occur. By reducing the dimensional errors and the mounting errors, the clearance between the coil 90 and the detected part 8 is easily set to a dimension according to the design value at each key 2. Thus, key press information of each key 2 can be detected with high accuracy.

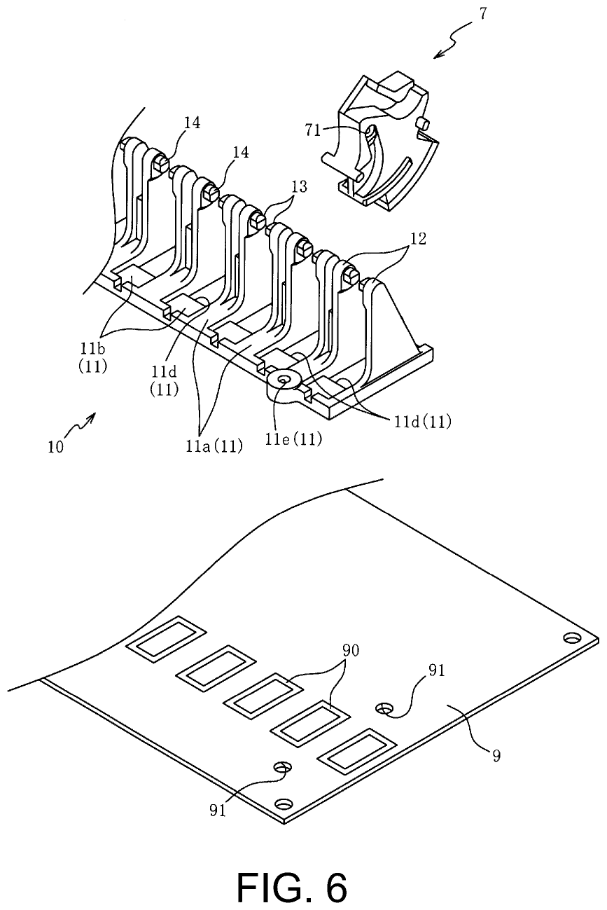

Further, as will be described in detail later, since a plurality of displacement members 7 arranged in the scale direction are supported on one holder 10 (refer to FIG. 6), for example, compared to a case where a separate holder 10 is provided for each of the plurality of displacement members 7 (one displacement member 7 is mounted by one holder 10 to the substrate 9), the clearance between the coil 90 and the detected part 8 is easily set to a dimension according to the design value at each key 2.

Furthermore, by fixing the holder 10, which extends in the scale direction, to the substrate 9, deformation of the substrate 9 can be restricted by the holder 10. With this configuration as well, the clearance between the coil 90 and the detected part 8 is easily set to a dimension according to the design value at each key 2.

Further, as long as the guide pin 65 of the hammer 6 and the groove 70 of the displacement member 7 are configured to be engageable with each other, that is, the displacement member 7 is configured to be rotatable in conjunction with the hammer 6, the shape of the displacement member 7 and the arrangement of the rotation shaft (shaft part 13) are freely changeable. In other words, by appropriately setting the shape of the displacement member 7 and the position of the rotation shaft, the arrangement of the coil 90 (arrangement of the coil 90 on the substrate 9 or arrangement of the substrate 9 itself) may also be changed to a desired position. Thus, design flexibility of the keyboard device 1 is improved.

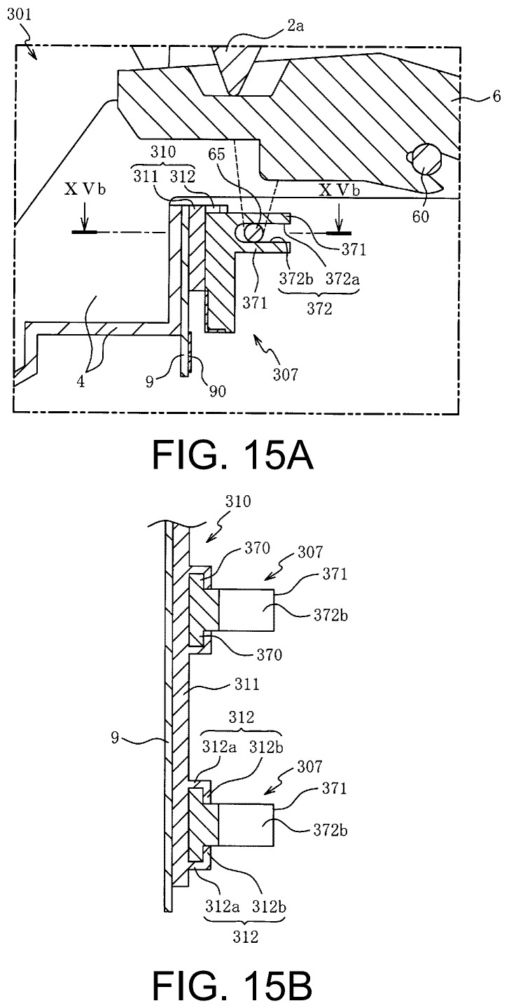

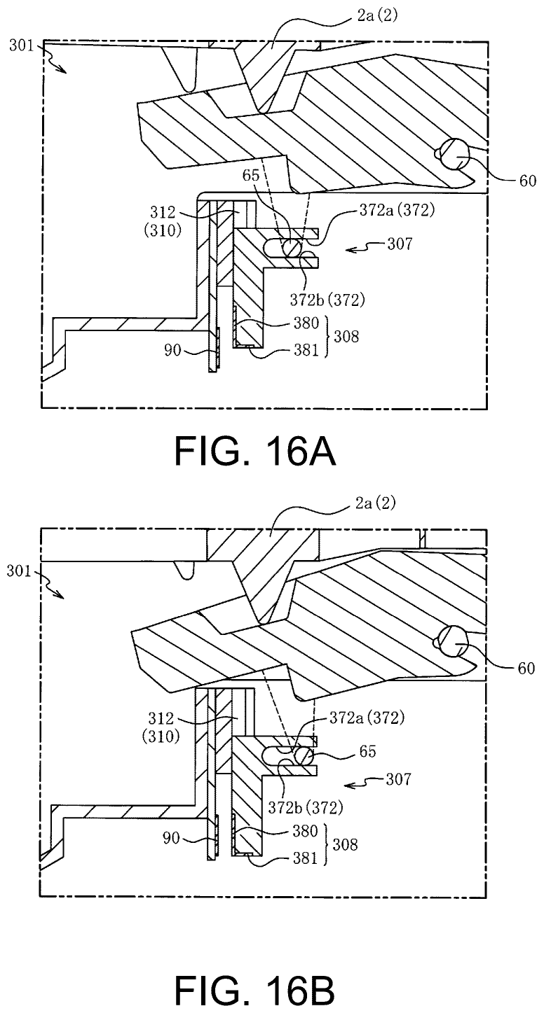

Herein, even with a configuration in which a displacement member 307 is supported slidably on a holder 310 fixed to the substrate 9, as in a third embodiment to be described later (refer to FIG. 15A to FIG. 16B), dimensional errors and mounting errors of the displacement member 307 can also be reduced. However, in the case of the configuration as in the third embodiment, the displacement member 307 may sometimes not slide smoothly with respect to the holder 310, and the touch when pressing the white key 2a is likely to deteriorate.

In contrast, in this embodiment, since the displacement member 7 is rotatably supported on the holder 10, the displacement member 7 can smoothly act in conjunction with the rotation of the hammer 6. Thus, deterioration in the touch when pressing the white key 2a can be suppressed.

As shown in FIG. 4B, the bottom surface 72 (opposing surface opposed to the coil 90) of the displacement member 7 is formed into an arc shape centered on the insertion hole 71 (refer to FIG. 3A and FIG. 3B). A front surface 73 of the displacement member 7 facing the front side (left side in FIG. 4B) in the rotation direction of the displacement member 7 and a rear surface 74 of the displacement member 7 facing the rear side (right side in FIG. 4B) in the same direction are connected to front and rear ends of the bottom surface 72 of the displacement member 7. The front surface 73 of the displacement member 7 is a planar surface extending in a normal direction of the bottom surface 72 from a front edge of the bottom surface 72, and the rear surface 74 is a planar surface extending in the normal direction of the bottom surface 72 from a rear edge of the bottom surface 72.

To change the magnetic field of the coil 90, although the detected part 8 may also be configured to be provided only on the bottom surface 72 of the displacement member 7, in this embodiment, the detected part 8 includes an opposing surface part 80 (opposed to the coil 90) covering the entire bottom surface 72 of the displacement member 7, and a front surface part 81 connected to a front end of the opposing surface part 80 and covering the front surface 73 of the displacement member 7. This is because, in a case where the detected part 8 is formed only on the bottom surface 72 of the displacement member 7, there would be a problem that, as shown by a broken line in FIG. 4A, the output value of the sensor temporarily increases (hereinafter referred to as an “overshoot of sensor output”) in an initial stage (when the stroke amount is around 2 mm) of key press of the white key 2a.

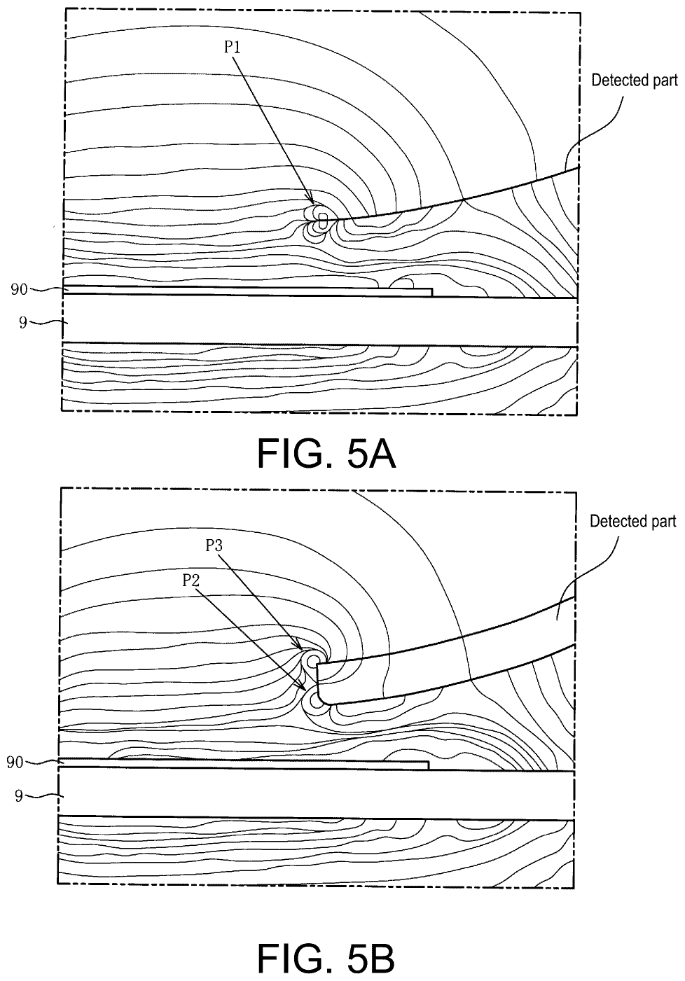

The overshoot of the sensor output will be described with reference to FIG. 5A and FIG. 5B. FIG. 5A is a schematic view of a magnetic field (magnetic field lines) in the case where a thin detected part is formed only on the bottom surface 72 of the displacement member 7, and FIG. 5B is a schematic view of a magnetic field (magnetic field lines) in the case where the detected part 8 (opposing surface part 80 and front surface part 81) is formed on the bottom surface 72 and the front surface 73 of the displacement member 7. FIG. 5A and FIG. 5B schematically illustrate magnetic fields analyzed using simulation software.

As shown in FIG. 5A, with the detected part 8 formed thinly (the detected part 8 is provided only on the bottom surface 72 of the displacement member 7), when the detected part 8 begins to enter the detection region (position opposed to the coil 90 on the substrate 9), the magnetic field lines (magnetic flux) concentrate at one point of a front edge portion P1 of the detected part 8. It is believed that the overshoot of the sensor output occurs due to this concentration of magnetic field lines at one point.

On the other hand, as shown in FIG. 5B, with the front surface part 81 provided in the detected part 8, when the detected part 8 begins to enter the detection region, concentration of magnetic field lines (magnetic flux) is dispersed between a connection portion P2 of the opposing surface part 80 and the front surface part 81 of the detected part 8, and an upper edge portion P3 of the front surface part 81. More specifically, a portion (P3) of the points at which the magnetic field lines concentrate is away from the region with a strong magnetic field close to the coil, which thus mitigates the impact on the change to the magnetic field. It is believed that, by dispersing the concentration of magnetic field lines in this manner, a sensor output without an overshoot is obtained, as shown by a solid line in FIG. 4A. By suppressing the overshoot of the sensor output, key press information can be detected with high accuracy.

In this case, with a configuration in which the detected part 8 is formed using a thick metal plate as in the related art (e.g., a metal plate 55 shown in FIG. 29 of Japanese Patent Application Laid-Open No. H03-048295), it is believed that an overshoot of the sensor output as described above can also be suppressed since a relatively wide up-down width of the front surface of the detected part 8 can be ensured. However, using a thick metal plate leads to an increase in weight and cost of the keyboard device 1.

In contrast, in this embodiment, as shown in FIG. 4B, the front surface 73 of the displacement member 7 is configured to be covered with the front surface part 81 which rises (bends) from the opposing surface part 80 of the detected part 8. With such a configuration, even if the thickness of the detected part 8 is small, a wide up-down width of the front surface part 81 can be ensured. In other words, since an overshoot of the sensor output can be suppressed without using a thick metal plate as in the related art described above, key press information can be detected with high accuracy while suppressing an increase in weight and an increase in cost of the keyboard device 1.

Further, in this embodiment, in addition to the front surface 73 of the displacement member 7, a rear surface part 82 of the detected part 8 is also provided on the rear surface 74 of the displacement member 7. The rear surface part 82 is connected to a rear end of the opposing surface part 80 of the detected part 8 and covers the rear surface 74 of the displacement member 7. Further, as shown in FIG. 4C, a pair of lateral surface parts 83 of the detected part 8 are provided on the lateral surfaces 75 of the displacement member 7. The lateral surface parts 83 rise upward from both ends of the opposing surface part 80 in the scale direction (left-right direction in FIG. 4C).

The formation of the rear surface part 82 and the lateral surface parts 83 in addition to the opposing surface part 80 and the front surface part 81 of the detected part 8 is intended to make it easy to form the detected part 8 at the displacement member 7 by plating. In other words, in the case of forming the detected part 8 at the displacement member 7 by plating, masking is applied to the displacement member 7, with a formation region of the detected part 8 exposed. By applying metal plating to the masked displacement member 7, the detected part 8 is not formed (plating does not adhere) in the region in which the masking is present, and the detected part 8 is formed on the outer surface of the displacement member 7 exposed from the masking.

In the case of forming the detected part 8 by such plating, for example, with a configuration in which the detected part 8 (opposing surface part 80 and front surface part 81) is provided only on the bottom surface 72 and the front surface 73 of the displacement member 7, it would be required to apply masking with a step on the front surface 73 and the lateral surfaces 75 of the displacement member 7. Thus, the work of masking the displacement member 7 requires considerable effort.

In contrast, in this embodiment, since the parts 80 to 83 of the detected part 8 are formed respectively on the bottom surface 72, the front surface 73, the rear surface 74, and the lateral surfaces 75 of the displacement member 7, the masking with a step as described above becomes unnecessary. Thus, masking of the displacement member 7 can be easily performed.

In this manner, since the detected part 8 of this embodiment is formed by plating metal on the outer surface of the displacement member 7, the thickness of each part 80 to 83 of the detected part 8 is substantially constant. The substantially constant thickness means that, for example, minimum and maximum thicknesses of the front surface part 81 are within a range of ±30% of an average value of the thicknesses of the parts 80 to 83 of the detected part 8.

Further, up-down width dimensions (rising heights from the opposing surface part 80) of the front surface part 81, the rear surface part 82, and the pair of lateral surface parts 83 of the detected part 8 are also substantially constant. The substantially constant up-down width dimension means that, for example, minimum and maximum up-down width dimensions of the front surface part 81 are within a range of ±30% of an average value of the up-down width dimensions of the parts 80 to 83 of the detected part 8.

In this manner, the up-down width dimension (rising height from the opposing surface part 80) of the front surface part 81 of the detected part 8 is substantially constant, and an upper edge 81a of the front surface part 81 of the detected part 8 is formed into a straight line shape along the scale direction (a direction perpendicular to the paper surface in FIG. 4B). Accordingly, compared to a case where a pointed portion is present at the upper edge 81a of the front surface part 81 (e.g., the upper edge 81a of the front surface part 81 is mountain-shaped), concentration of magnetic field changes at a part of the upper edge 81a of the front surface part 81 can be suppressed. Thus, key press information can be detected with high accuracy.

Further, the detected part 8 includes a curved part 84 that is curved and connects the opposing surface part 80 and the front surface part 81. Since the curved part 84 smoothly connects a boundary (corner) portion between a front end of the opposing surface part 80 and a lower end of the front surface part 81, concentration of magnetic field changes at the boundary portion can be suppressed. Thus, key press information can be detected with high accuracy.

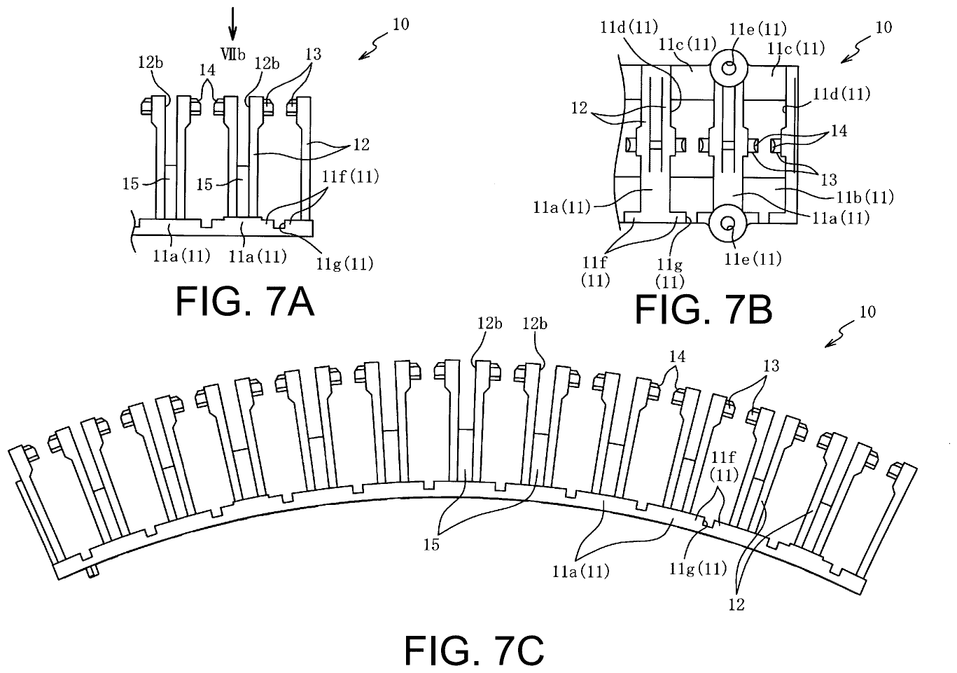

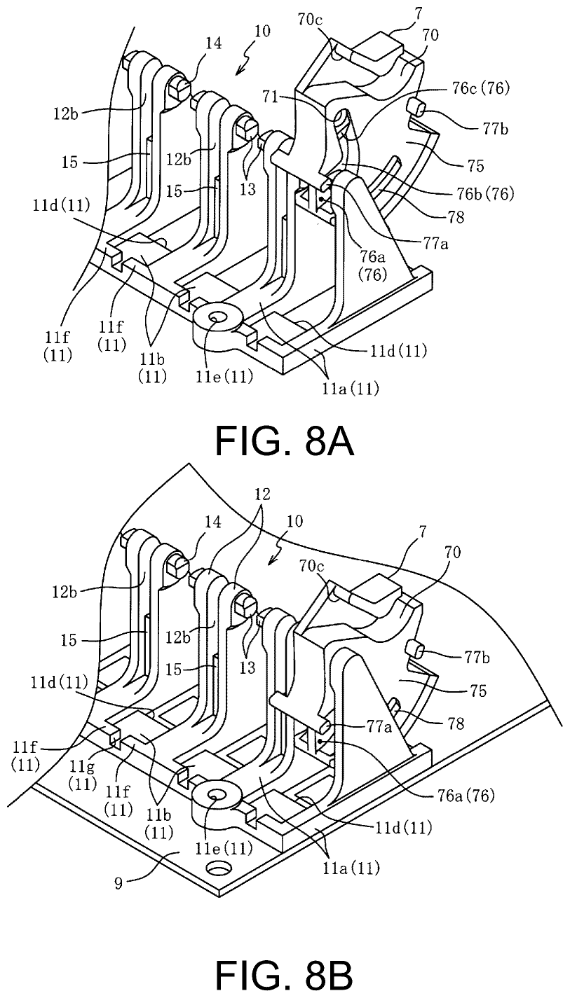

Next, referring to FIG. 6 to FIG. 8B, a method for mounting the displacement member 7 to the substrate 9 (holder 10) will be described. FIG. 6 is an exploded perspective view of the keyboard device 1. FIG. 7A is a partially enlarged front view of the holder 10, FIG. 7B is a partially enlarged top view of the holder 10 as viewed in a direction of an arrow VIIb in FIG. 7A, and FIG. 7C is a front view of the holder 10 showing the holder 10 in a bent state. FIG. 8A is a perspective view showing sliding of the shaft part 13 of the holder 10 along the guide groove 76, and FIG. 8B is a perspective view showing a state in which the holder 10 mounted with the displacement member 7 is fixed to the substrate 9.

As shown in FIG. 6, a plurality of coils 90 are arranged in the scale direction on the substrate 9, and a plurality of displacement members 7 are pivotally supported by the holder 10 above each of the coils 90. The mounting of the displacement member 7 and the holder 10 to the substrate 9 is performed by mounting the displacement member 7 to the holder 10 and then fixing the holder 10 to the substrate 9.

As shown in FIG. 6 to FIG. 7C, the mounted part 11 of the holder 10, which is fixed to the upper surface of the substrate 9, includes a base part 11a from which the wall part 12 rises, and connecting parts 11b and 11c (refer to FIG. 7B for the connecting part 11c) that connect the base parts 11a to each other. The parts 11a to 11c are integrally formed using a resin material (synthetic resin).

The base part 11a extends from a lower end of the wall part 12 to both the front and rear sides, and front and rear end portions of the base part 11a are connected in the scale direction by the connecting parts 11b and 11c. Thus, a through-hole 11d in a rectangular shape surrounded by the base parts 11a and the connecting parts 11b and 11c is formed at the mounted part 11. The through-holes 11d are arranged in the scale direction at arrangement intervals corresponding to the coils 90 of the substrate 9.

A plurality of screw holes 11e are formed at the mounted part 11, and the holder 10 is fixed to the substrate 9 by screwing screws (not shown), which are inserted into through-holes 91 of the substrate 9, into the screw holes 11e of the mounted part 11.

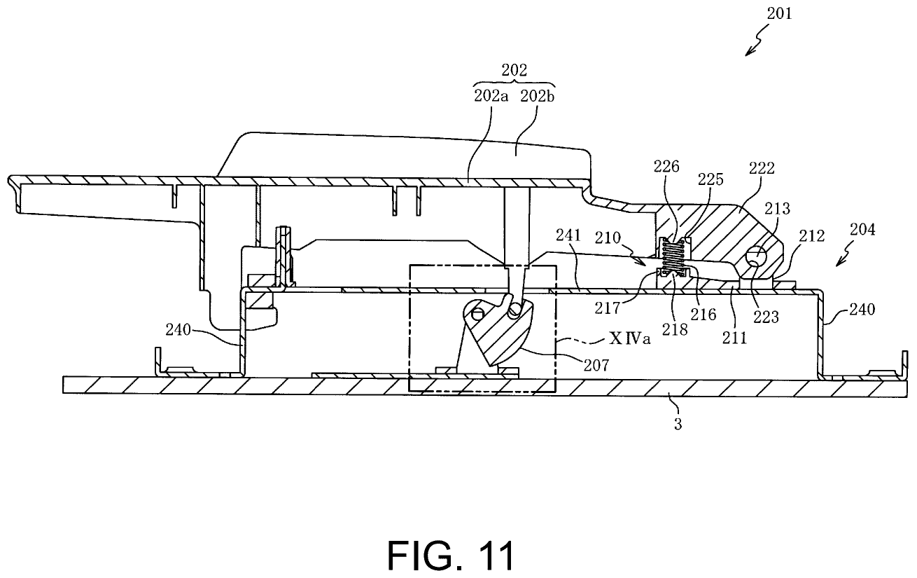

Since a plurality of displacement members 7 arranged in the scale direction are mounted to the holder 10, in this embodiment, while mounting thereof is facilitated, fall-off of the displacement members 7 after mounting can be suppressed. This configuration will be described below, and such an objective of “suppressing fall-off while facilitating mounting of rotating members” is similar in the key 2 and the hammer 6. A support structure of a key 202 that addresses this objective will be described later in a second embodiment (FIG. 11 to FIG. 13B).

In this embodiment, the base parts 11a of the mounted part 11 of the holder 10 are connected by the connecting parts 11b and 11c in a flat plate shape. Thus, in a state before the holder 10 is fixed to the substrate 9, as shown in FIG. 7C, the mounted part 11 (connecting parts 11b and 11c) may be bent. By bending the mounted part 11, since an opposing interval between the shaft parts 13 formed at the wall parts 12 slightly widens, as shown in FIG. 8A, when mounting the displacement member 7 to the holder 10, the pair of shaft parts 13 can be easily inserted into the insertion holes 71 of the displacement member 7. Accordingly, workability of the mounting work of the displacement member 7 can be improved.

On the other hand, after mounting the displacement member 7 to the holder 10, as shown in FIG. 8B, by fixing the holder 10 to the substrate 9, which has a relatively high rigidity (compared to the holder 10), widening of the opposing interval between the shaft parts 13 of the wall parts 12 (bending of the mounted part 11) can be suppressed. Accordingly, since disengagement of the shaft parts 13 from the insertion holes 71 of the displacement member 7 can be suppressed, fall-off of the displacement member 7 from the holder 10 can be suppressed.

As shown in FIG. 7A to FIG. 8B, the thickness of the connecting parts 11b and 11c connecting the base parts 11a to each other is less than the thickness of the base part 11a from which the wall part 12 rises. By forming such a thin-walled portion between the base parts 11a, it becomes easy to widen the opposing interval between the wall parts 12 (shaft parts 13) to bend the mounted part 11.

Further, since the through-hole 11d is formed between the connecting parts 11b and 11c (between the wall parts 12), with this configuration as well, the mounted part 11 bends easily. By forming the mounted part 11 to bend easily, the pair of shaft parts 13 can be easily inserted into the insertion holes 71 of the displacement member 7.

Herein, a surrounding of the screw hole 11e of the mounted part 11 needs to be formed relatively thick because it is subject to an axial force of the screw. Thus, for example, if the screw hole 11e is provided on the front side and the rear side (a region in which the connecting parts 11b and 11c are formed) in the opposing interval between the wall parts 12, deformation of the mounted part 11, such as widening the opposing interval between the wall parts 12 (shaft parts 13), is likely to be hindered.

In contrast, in this embodiment, since the screw holes 11e are formed at both front and rear end sides of the base part 11a, the thicknesses on the front side and the rear side (regions in which the connecting parts 11b and 11c are formed) in the opposing interval between the wall parts 12 can be reduced. Accordingly, since it becomes easy to widen the opposing interval between the wall parts 12 (shaft parts 13) to bend the mounted part 11, the pair of shaft parts 13 can be easily inserted into the insertion holes 71 of the displacement member 7.

The insertion of the shaft part 13 into the insertion hole 71 is guided by a guide groove 76 formed on each of the pair of lateral surfaces 75 of the displacement member 7 (refer to FIG. 8A). The guide groove 76 bends to the front side while extending downward from the insertion hole 71, and an opening part 76a of the guide groove 76 is formed at a front end part of the displacement member 7. A thickness of the displacement member 7 in the scale direction in a region in which the opening part 76a is formed is formed to be less than the opposing interval of the pair of shaft parts 13. In other words, each guide groove 76 formed on the pair of lateral surfaces 75 of the displacement member 7 is configured to be capable of receiving the pair of shaft parts 13 from the opening part 76a thereof.

In this manner, since the guide groove 76 is configured such that one end side of the guide groove 76 is connected to the insertion hole 71 and the shaft part 13 is capable of being received from the opening part 76a on the other end side, by sliding the shaft part 13, which is received from the opening part 76a, along the guide groove 76, the shaft part 13 can be guided toward the insertion hole 71. Thus, the pair of shaft parts 13 can be easily inserted into the insertion holes 71 of the displacement member 7.

Herein, a surface of the guide groove 76 that faces the scale direction (opposed to the tip of the shaft part 13) is defined as a groove bottom surface 76b. On the groove bottom surface 76b, the thickness of the displacement member 7 in the scale direction is increased to form an inclined surface 76c that rises and inclines toward the insertion hole 71. When the shaft part 13 slides along the inclined surface 76c, the opposing interval of the pair of shaft parts 13 automatically expands due to elastic deformation of the wall parts 12. Thus, since the need for an operator to widen the opposing interval of the shaft parts 13 with fingers is eliminated, the pair of shaft parts 13 can be easily inserted into the insertion holes 71 of the displacement member 7.

In this embodiment, the inclined surface 76c is formed near the insertion hole 71. However, for example, an inclination equivalent to the inclined surface 76c may also be provided near the opening part 76a. In other words, a formation position of the inclined surface 76c in the groove 70 can be set as appropriate. The expression “near the insertion hole 71” refers to a position at which a distance from the inclined surface 76c to the insertion hole 71 is less than a distance from the opening part 76a to the inclined surface 76c.

When the shaft part 13 slides along the inclined surface 76c of the guide groove 76, an inclined surface 14 formed at the shaft part 13 slides against the inclined surface 76c. The inclined surface 14 rises and inclines in a manner of obliquely cutting out an upper end of a tip surface of the shaft part 13 (in a manner away from the opposing shaft part 13). In other words, since the inclined surface 14 is inclined in a direction corresponding to the inclined surface 76c of the guide groove 76, the inclined surfaces 14 and 76c slide against each other when the shaft part 13 slides along the inclined surface 76c. Accordingly, for example, compared to a case where the inclined surface 14 is not formed at the shaft part 13, the shaft part 13 can be smoothly slid against the inclined surface 76c. Thus, the pair of shaft parts 13 can be easily inserted into the insertion holes 71 of the displacement member 7.

By inserting the pair of shaft parts 13 into the insertion holes 71, mounting of the displacement member 7 to the holder 10 is completed. After the mounting of the displacement member 7, fall-off of the displacement member 7 due to elastic deformation of the holder 10 (the mounted part 11 and the wall part 12) can be largely suppressed by fixing the holder 10 to the substrate 9 as described above.

However, although the substrate 9 has a relatively high rigidity (compared to the holder 10), deformation may still occur. Thus, to more reliably prevent fall-off of the displacement member 7, a certain degree of rigidity is also necessary for the holder 10.

Thus, in this embodiment, a linking part 15 that links the outer surfaces 12b of the wall parts 12 to each other is formed at the holder 10. By providing such a linking part 15, widening of the opposing interval between the wall parts 12 after mounting the holder 10 to the substrate 9 can be restricted by the linking part 15. Thus, fall-off of the displacement member 7 from the holder 10 can be suppressed.

On the other hand, if the entirety (from an upper end to a lower end) of the outer surface 12b of the wall part 12 is linked by the linking part 15, it becomes difficult for the wall part 12 to elastically deform when the shaft part 13 slides along the inclined surface 76c of the guide groove 76. Thus, in this embodiment, only a region on a lower end side of the outer surface 12b of the wall part 12 is linked by the linking part 15. In other words, the linking part 15 links the outer surfaces 12b of the wall parts 12 to each other on the lower side (mounted part 11 side) of the shaft parts 13, and in a region in which the shaft parts 13 are formed (a position overlapping with the shaft parts 13 in the scale direction), a gap is formed between the outer surfaces 12b.

With this gap, since elastic deformation of the wall part 12 is allowed when the shaft part 13 slides along the inclined surface 76c of the guide groove 76, the pair of shaft parts 13 can be easily inserted into the insertion holes 71 of the displacement member 7. In this manner, in the up-down direction (rising direction of the wall parts 12 from the base part 11a), by linking partial regions of the outer surfaces 12b of the wall parts 12 by the linking part 15, the wall parts 12 can be elastically deformed to an appropriate degree. Thus, while facilitating mounting of the displacement member 7 to the holder 10, fall-off of the displacement member 7 from the holder 10 after mounting can be suppressed.

Further, in this embodiment, to provide a certain degree of rigidity to the holder 10, of the connecting parts 11b and 11c, a thick-walled part 11f is formed at the connecting part 11b connecting front ends of the base parts 11a. The thick-walled part 11f is a portion formed with a same thickness as the base part 11a. The thick-walled part 11f extends in the scale direction from a front end portion of the base part 11a, and a notched part 11g is formed at a central portion of the thick-walled part 11f in the scale direction.

By providing the thick-walled part 11f and the notched part 11g, the mounted part 11 (connecting parts 11b and 11c) can be elastically deformed to an appropriate degree. In other words, while allowing the mounted part 11 to bend (refer to FIG. 7C), elastic deformation of the mounted part 11 can be suppressed after being fixed to the substrate 9. Thus, while facilitating mounting of the displacement member 7 to the holder 10, fall-off of the displacement member 7 from the holder 10 after mounting can be suppressed.

After fixing the holder 10, which is mounted with the displacement member 7, to the substrate 9, assembly works are performed, such as inserting the guide pin 65 (refer to FIG. 3A and FIG. 3B) of the hammer 6 from an opening part 70c (refer to FIG. 8A and FIG. 8B) of the groove 70 formed above the wall part 12. Since workability would deteriorate if the displacement member 7 rotates excessively with respect to the holder 10 during such assembly works, protrusions 77a and 77b are formed at the displacement member 7 to restrict rotation thereof.

The protrusions 77a and 77b are protrusions that protrude in the scale direction from the lateral surface 75 of the displacement member 7. With the displacement member 7 mounted to the holder 10, the protrusion 77a is positioned on the front side (front side in the rotation direction of the displacement member 7) of the wall part 12, and the protrusion 77b is positioned on the rear side of the wall part 12. Accordingly, excessive rotation of the displacement member 7 with respect to the holder 10 can be restricted by contact between the protrusions 77a and 77b and the wall part 12. Thus, workability of the assembly work described above can be improved.

In this embodiment, the protrusions 77a and 77b are formed on each of the pair of lateral surfaces 75 of the displacement member 7. However, the protrusions 77a and 77b may also be formed on only one lateral surface 75 of the pair of lateral surfaces 75.

Further, a guide part 78 is formed at the displacement member 7 to stabilize rotation of the displacement member 7 with respect to the holder 10. The guide part 78 is a protrusion that protrudes in the scale direction from each of the pair of lateral surfaces 75 of the displacement member 7. By providing such a guide part 78, rotation of the displacement member 7 around the shaft parts 13 can be guided by contact between the guide part 78 and the wall part 12. Accordingly, since the detected part 8 rotates easily while maintaining a predetermined clearance with respect to the coil 90 of the substrate 9, key press information can be detected with high accuracy.

Since the guide part 78 extends in an arc shape centered on the insertion hole 71 (the shaft part 13 which is the rotation shaft of the displacement member 7), while it becomes possible to guide rotation of the displacement member 7 by the guide part 78, a contact area of the guide part 78 with respect to the wall part 12 can be reduced. Thus, the guide part 78 easily slides smoothly against the wall part 12.

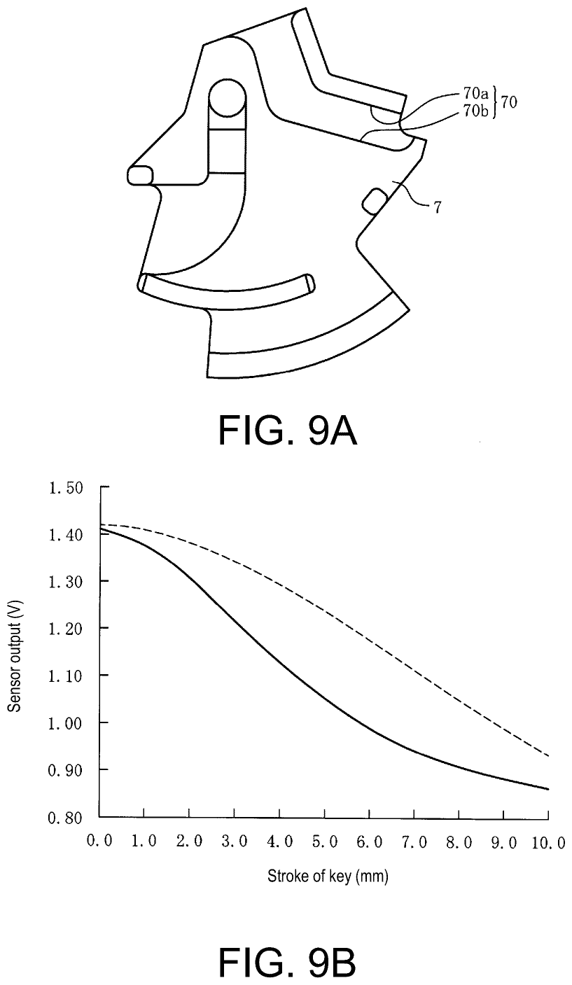

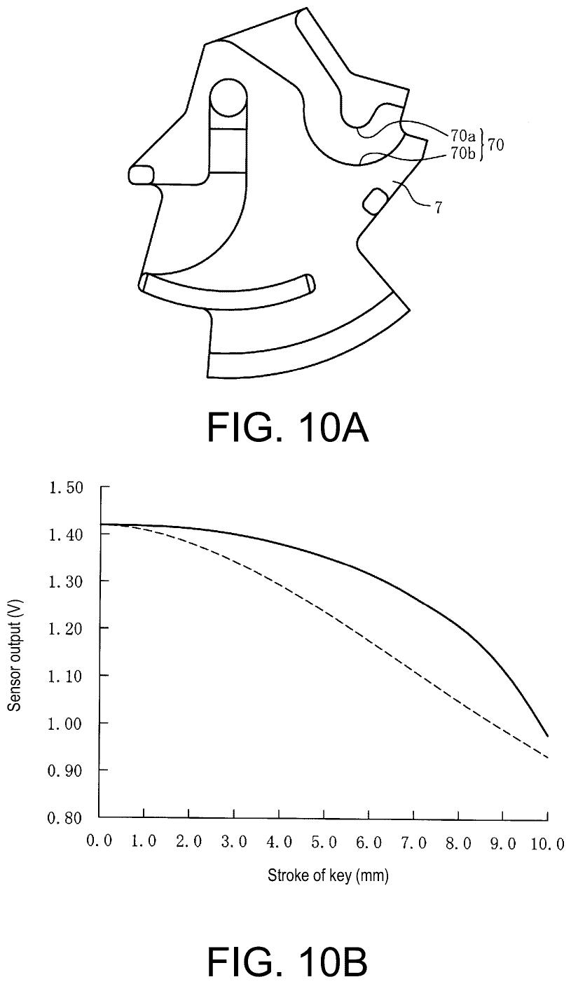

Next, referring to FIG. 9A to FIG. 10B, modification examples of the displacement member 7 will be described. In the first embodiment described above, the case where the sensor output decreases approximately proportionally to the stroke amount of the key 2 during key press has been described.

In contrast, the modification examples in FIG. 9A to FIG. 10B describe a configuration that increases the rate of decrease in the sensor output with respect to the stroke amount of the key 2 during key press, and a configuration that makes the decrease in the sensor output more gradual, compared to the first embodiment described above.

FIG. 9A is a side view of a displacement member 7 showing a first modification example, and FIG. 9B is a graph showing a relationship between a stroke amount of key press and a sensor output in the case of using the displacement member 7 of the first modification example. FIG. 10A is a side view of a displacement member 7 showing a second modification example, and FIG. 10B is a graph showing a relationship between a stroke amount of key press and a sensor output in the case of using the displacement member 7 of the second modification example. In FIG. 9B and FIG. 10B, the sensor output in the case of the displacement member 7 of the first embodiment described above is shown by a broken line.

Further, each modification example in FIG. 9A to FIG. 10B has the same configuration as the displacement member 7 of the first embodiment described above, except that the shape of the groove 70 (upper sliding surface 70a and lower sliding surface 70b) is different. Thus, in each modification example in FIG. 9A to FIG. 10B, the same reference signs as in the first embodiment are labeled for description.

As shown in FIG. 9A, the groove 70 of the displacement member 7 in the first modification example has an upper sliding surface 70a and a lower sliding surface 70b formed into a straight line shape. In other words, in the first modification example, a radius of curvature of each sliding surface 70a and 70b is increased compared to the first embodiment described above. By configuring such a shape of the groove 70, the rotation amount of the displacement member 7 with respect to the stroke amount of the key 2 (i.e., rotation amount of the guide pin 65 around the rotation shaft 60 shown in FIG. 3A and FIG. 3B) increases compared to the first embodiment. Thus, according to the displacement member 7 of the first modification example, as shown in FIG. 9B, the rate of decrease in the sensor output with respect to the stroke amount of the key 2 during key press can be increased compared to the first embodiment.

As shown in FIG. 10A, in the groove 70 of the displacement member 7 in the second modification example, the radii of curvature of the upper sliding surface 70a and the lower sliding surface 70b are reduced compared to the first embodiment. By configuring such a shape of the groove 70, the rotation amount of the displacement member 7 with respect to the stroke amount of the key 2 decreases compared to the first embodiment. Thus, according to the displacement member 7 of the second modification example, as shown in FIG. 10B, the rate of decrease in the sensor output with respect to the stroke amount of the key 2 during key press can be made more gradual compared to the first embodiment.

In this manner, in the first embodiment and the modification examples shown in FIG. 9A to FIG. 10B, since the displacement member 7 rotates by the sliding between the guide pin 65 (refer to FIG. 3A and FIG. 3B) of the hammer 6 and the groove 70, the sensor output (i.e., displacement pattern of the displacement member 7) can be adjusted by changing the shape of the groove 70. In other words, by mounting a displacement member 7 corresponding to a sensor output required by a user to the keyboard device 1, or by replacing the displacement member 7 mounted to the keyboard device 1, a sensor output that meets the user's requirement can be obtained.

In the case of performing adjustment on the sensor output in this manner, it is also possible to adopt a configuration in which the groove 70 is formed on the hammer 6 side, and the guide pin 65 is formed on the displacement member 7 side, for example. However, the hammer 6 itself is large in dimension and is expensive. Thus, if the groove 70 is formed on the hammer 6 side, the cost increases when replacing with a hammer 6 having a different shape of the groove 70 (i.e., changing the sensor output).

In contrast, the displacement member 7 can be formed to be smaller (less expensive) compared to the hammer 6. Thus, by forming the groove 70 on the displacement member 7 side and forming the guide pin 65 on the hammer 6 side, the cost can be reduced when replacing with a displacement member 7 having a different shape of the groove 70 (i.e., changing the sensor output).

In the displacement member 7 shown in the first embodiment and in FIG. 9A to FIG. 10B, it has been described that the upper sliding surface 70a and the lower sliding surface 70b of the groove 70 have corresponding shapes (the interval between the sliding surfaces 70a and 70b is constant), that is, the correlation between the stroke amount of the key 2 and the sensor output is the same during key press and during key release. However, the embodiment is not necessarily limited thereto.

For example, the shape of the upper sliding surface 70a (refer to FIG. 3A and FIG. 3B) of the first embodiment may be changed to the shape of the upper sliding surface 70a (refer to FIG. 9A) of the first modification example. In other words, by changing the interval between the sliding surfaces 70a and 70b in a part (or all) of the region in which the guide pin 65 slides, the correlation between the stroke amount of the key 2 and the sensor output may be configured to differ during key press and during key release.

Next, referring to FIG. 11 to FIG. 14B, a keyboard device 201 of a second embodiment will be described. The first embodiment above has described the case where the displacement member 7 is rotatably supported by the holder 10, and the case where the displacement member 7 is rotated by the hammer 6. In contrast, the second embodiment will describe a configuration in which a key 202 is supported by a holder 210 having a similar configuration to the holder 10, and a case where a displacement member 207 is displaced by the key 202. Same portions as in the first embodiment described above will be labeled with the same reference signs, and descriptions thereof will be omitted.

First, referring to FIG. 11, an overall configuration of the keyboard device 201 of the second embodiment will be described. FIG. 11 is a cross-sectional view of the keyboard device 201 of the second embodiment. FIG. 11 illustrates a cross-section cut in a plane orthogonal to the scale direction (arrangement direction of the plurality of keys 202) of the keyboard device 201.

As shown in FIG. 11, the keyboard device 201 of the second embodiment includes a chassis 204 supported on a bottom plate 3. The chassis 204 includes a pair of legs 240 spaced apart by a predetermined interval in the front-rear direction, and a support part 241 connecting upper ends of the pair of legs 240 in the front-rear direction. The legs 240 and the support part 241 are integrally formed using a synthetic resin, a steel plate, etc., and a holder 210 is fixed to an upper surface of the support part 241. A plurality of keys 202 (white keys 202a and black keys 202b) arranged in the scale direction are rotatably supported on the holder 210.

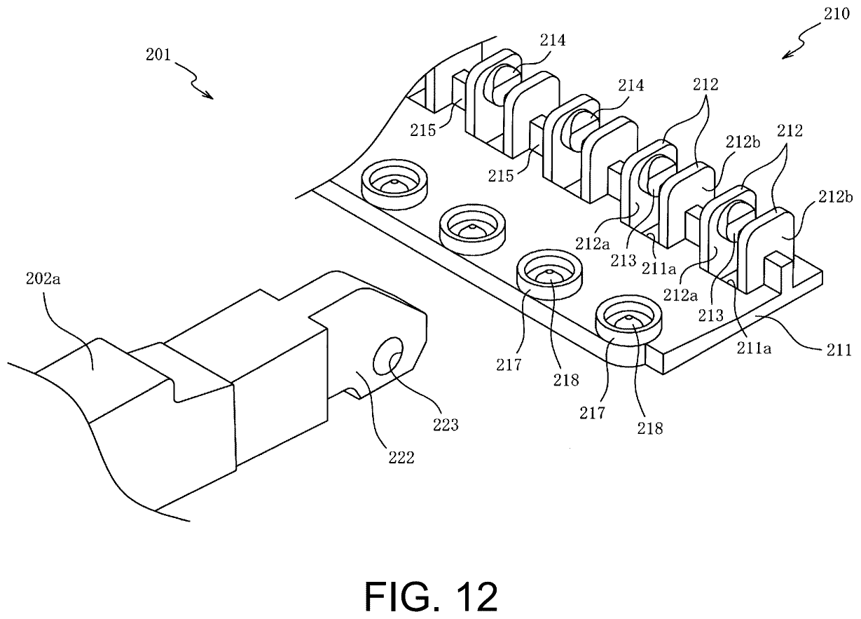

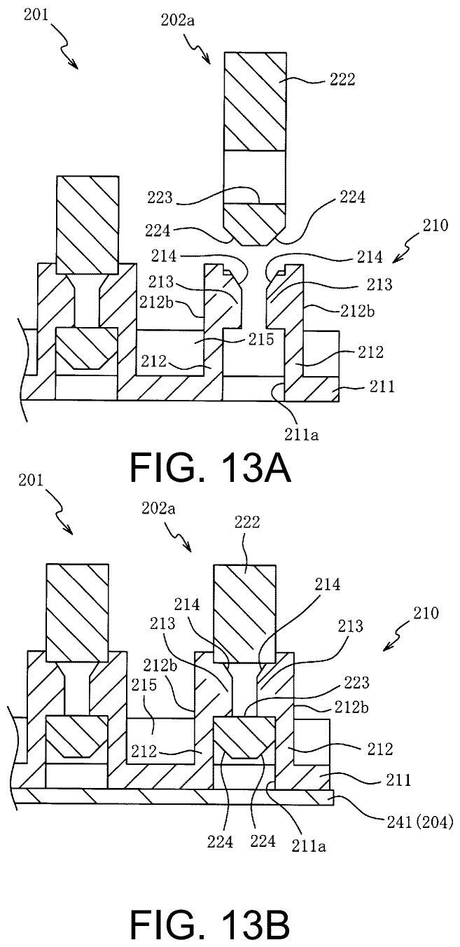

A support structure for the key 202 supported by the holder 210 will be described with reference to FIG. 11 to FIG. 13B. FIG. 12 is an exploded perspective view of the keyboard device 201. FIG. 13A is a partially enlarged cross-sectional view of the keyboard device 201 showing fitting of a shaft part 213 of the holder 210 into an insertion hole 223 of the white key 202a, and FIG. 13B is a partially enlarged cross-sectional view of the keyboard device 201 showing a state in which the shaft part 213 of the holder 210 is fitted into the insertion hole 223 of the white key 202a.

As shown in FIG. 11 and FIG. 12, a protruding part 222 protrudes to the rear side from a rear end part of the white key 202a. The protruding part 222 is formed into a plate shape with a smaller dimension in the scale direction than the white key 202a (portion to be pressed) (refer to FIG. 12), and the insertion hole 223 which penetrates in the scale direction is formed at the protruding part 222.

The holder 210 includes a mounted part 211 mounted to an upper surface of the chassis 204 (support part 241), a wall part 212 rising upward from the mounted part 211, and a shaft part 213 in a substantially cylindrical shape formed on an upper end side of the wall part 212. The parts 211 to 213 are integrally formed using a resin material (synthetic resin). A plurality of wall parts 212 are arranged in the scale direction, and the protruding part 222 of the white key 202a is rotatably supported in an opposing interval between the plurality of wall parts 212.

In the following description, of lateral surfaces (surfaces facing the scale direction) of the wall part 212, a lateral surface that sandwiches the protruding part 222 will be described as an inner surface 212a of the wall part 212 (refer to FIG. 12), and a lateral surface opposite to the inner surface 212a will be described as an outer surface 212b. The shaft part 213 protrudes in the scale direction from the inner surface 212a of the wall part 212.

Since the mounted part 211 is formed into a plate shape extending in the scale direction, although not shown, in the state before fixing the holder 210 to the support part 241 (refer to FIG. 11) of the chassis 204, the mounted part 211 can be bent. By bending the mounted part 211, since the opposing interval between the shaft parts 213 formed at the wall parts 212 slightly widens, as shown in FIG. 13A, when mounting the white key 202a to the holder 210, the pair of shaft parts 213 can be easily inserted into the insertion hole 223 of the white key 202a. Thus, workability of the mounting work of the white key 202a can be improved.

On the other hand, after mounting the white key 202a to the holder 210, as shown in FIG. 13B, by fixing the holder 210 to the chassis 204 (support part 241) which has a higher rigidity than the holder 210 (mounted part 211), bending of the mounted part 211 can be suppressed. Accordingly, since widening of the opposing interval between the shaft parts 213 can be suppressed, disengagement of the shaft parts 213 from the insertion hole 223 of the white key 202a can be suppressed. Thus, fall-off of the white key 202a from the holder 210 can be suppressed.

Further, since the mounted part 211 includes a through-hole 211a formed between the opposing wall parts 212 sandwiching the protruding part 222, the mounted part 211 easily bends. Thus, the pair of shaft parts 213 can be easily inserted into the insertion hole 223 of the white key 202a.

In this embodiment, the mounted part 211 is formed into an almost flat plate shape, but unevenness (e.g., rib-shaped protrusions) may also be formed at the mounted part 211. In other words, as long as the mounted part 211 is configured to be capable of being bent, the shape of the mounted part 211 may be appropriately set and is not limited to a flat plate shape.

When inserting the protruding part 222 of the white key 202a between the shaft parts 213, the insertion is guided by an inclined surface 224 formed at the protruding part 222 and an inclined surface 214 formed at the shaft part 213. The inclined surface 224 is formed as a pair of inclined surfaces 224 at an end part on both sides of a lower surface of the protruding part 222 in the scale direction, and the pair of inclined surfaces 224 rise and incline toward a scale direction outer side.

On the other hand, the inclined surface 214 of the shaft part 213 rises and inclines in a manner of obliquely cutting out an upper end of a tip surface of the shaft part 213 (in a manner away from the opposing shaft part 213). In other words, since the inclined surface 214 of the shaft part 213 inclines in a direction corresponding to the inclined surface 224 of the white key 202a, by inserting the protruding part 222 of the white key 202a from above into the opposing interval between the pair of shaft parts 213, the respective inclined surfaces 214 and 224 slide against each other. Due to this sliding, since the wall parts 212 elastically deform and the opposing interval of the pair of shaft parts 213 automatically expands, the shaft parts 213 can be easily inserted into the insertion hole 223 of the white key 202a.

By inserting the pair of shaft parts 213 into the insertion hole 223, the mounting of the white key 202a to the holder 210 is completed. Since the outer surfaces 212b of the wall parts 212 are linked by a linking part 215, the widening of the opposing interval between the wall parts 212 after mounting the holder 210 to the chassis 204 (support part 241) can be restricted by the linking part 215. Thus, fall-off of the white key 202a from the holder 210 can be suppressed.

The linking part 215 links the outer surfaces 212b of the wall parts 212 on the lower side (mounted part 211 side) of the shaft parts 213, and in a region in which the shaft parts 213 are formed (a position overlapping with the shaft parts 213 in the scale direction), a gap is formed between the outer surfaces 212b. Accordingly, the wall parts 212 can be elastically deformed appropriately. Thus, while facilitating mounting of the white key 202a to the holder 210, fall-off of the white key 202a from the holder 210 after mounting can be suppressed.

A retaining wall 217 in a cylindrical shape for retaining a coil spring 216 is formed on an upper surface on a front end side of the mounted part 211, and a plurality of retaining walls 217 are arranged in the scale direction. A protrusion 218 in a conical shape protruding upward is formed at a central portion on an inner circumferential side of each retaining wall 217.

A recess 225 (refer to FIG. 11) is formed at a position opposed to the retaining wall 217 in the up-down direction on a lower surface of the white key 202a, and a protrusion 226 in a conical shape protruding downward is formed on an inner circumferential side of the recess 225. With the coil spring 216 sandwiched from above and below by the protrusion 218 of the mounted part 211 and the protrusion 226 of the white key 202a, the coil spring 216 is retained on the inner circumferential side of the retaining wall 217 and the recess 225.

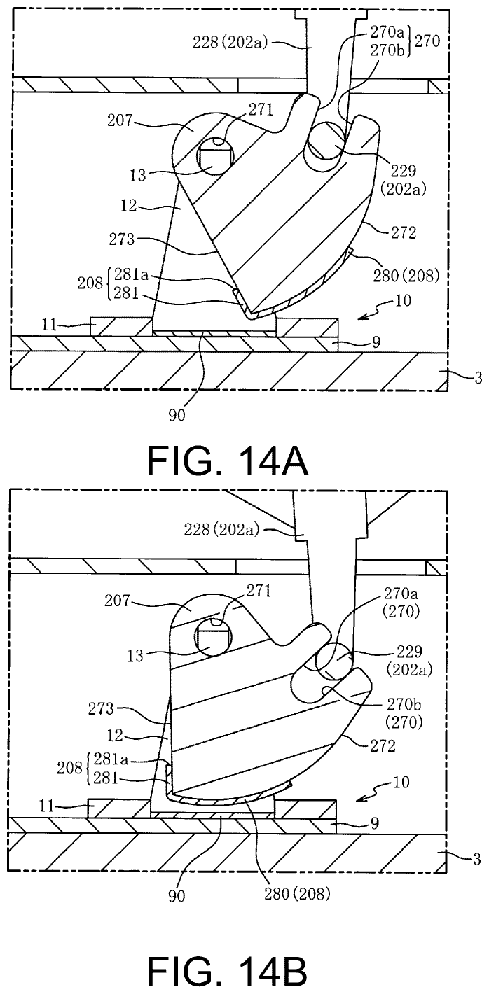

During key press of the white key 202a, a key press touch is imparted by the elastic force of the coil spring 216, and during key release, the white key 202a returns to an initial position by the elastic restoring force of the coil spring 216. During such key press and key release, the displacement member 207 acts in conjunction with the rotation of the white key 202a around the shaft parts 213. A detailed configuration causing the displacement member 207 to act in conjunction will be described with reference to FIG. 14A and FIG. 14B.

FIG. 14A is a partially enlarged cross-sectional view of the keyboard device 201 showing an enlarged view of a portion XIVa in FIG. 11, and FIG. 14B is a partially enlarged cross-sectional view of the keyboard device 201 showing a state in which the white key 202a is pressed to a terminal position from the state in FIG. 14A.

As shown in FIG. 14A, a protruding part 228 protrudes downward from a lower surface of the white key 202a, and a guide pin 229 protrudes in the scale direction from a lateral surface of the protruding part 228. The protruding part 228 and the guide pin 229 are integrally formed with the white key 202a.

The guide pin 229 slidably engages with a groove 270 formed at the displacement member 207. An insertion hole 271 penetrating in the scale direction is formed at the displacement member 207, and by inserting a shaft part 13 of a holder 10 into the insertion hole 271, the displacement member 207 is rotatably supported on the holder 10. The substrate 9 to which the holder 10 is fixed is supported on the bottom plate 3.

The rotation of the displacement member 207 with respect to the shaft parts 13 is performed by the sliding between the guide pin 229 of the white key 202a and the groove 270 formed at the displacement member 207 described above. An upper sliding surface 270a and a lower sliding surface 270b of the groove 270 are formed in parallel (in a straight line shape).

In the initial state before the white key 202a is pressed, each sliding surface 270a and 270b of the groove 270 extends to intersect with a displacement trajectory of the guide pin 229 around the shaft parts 213 (refer to FIG. 11).

Thus, as shown in FIG. 14B, upon rotation of the guide pin 229 around the shaft parts 213 (refer to FIG. 11) during key press, the lower sliding surface 270b is pushed downward by the guide pin 229. Accordingly, the displacement member 207 rotates around the shaft parts 13, and along with this rotation, an entry amount of a detected part 208 into a detection region opposed to the coil 90 increases.

On the other hand, during key release of the white key 202a, the guide pin 229 rotates around the shaft parts 213 (refer to FIG. 11) to return to the initial state by the elastic restoring force of the coil spring 216 (refer to FIG. 11). Due to this rotation of the guide pin 229, with the upper sliding surface 270a pushed upward by the guide pin 229, the displacement member 207 rotates around the shaft parts 13, and the entry amount of the detected part 208 with respect to the detection region decreases.

In this embodiment as well, the detected part 208 is configured to be provided at the displacement member 207 which acts in conjunction with the white key 202a. Since the displacement member 207 may be formed to be smaller compared to the white key 202a and the hammer 6 (refer to FIG. 1), dimensional errors are less likely to occur in each displacement member 207. Furthermore, since the displacement member 207 is configured to be pivotally supported on a relatively small holder 10 mounted to the substrate 9 rather than on the chassis 204, mounting errors of each displacement member 207 are also less likely to occur. Accordingly, since a clearance between the coil 90 and the detected part 208 is easily set to a dimension according to a design value at each key 202, key press information of each key 202 can be detected with high accuracy.

Further, as long as the guide pin 229 of the white key 202a and the groove 270 of the displacement member 207 are configured to be engageable with each other, that is, the displacement member 207 is configured to be rotatable in conjunction with the white key 202a, the shape of the displacement member 207 and the arrangement of the rotation shaft (shaft part 13) is freely changeable. In other words, by appropriately setting the shape of the displacement member 207 and the position of the rotation shaft, the arrangement of the coil 90 may also be changed to a desired position. Thus, design flexibility of the keyboard device 201 is improved.

The detected part 208 includes an opposing surface part 280 covering the bottom surface 272 of the displacement member 207 (opposed to the coil 90), and a front surface part 281 connected to a front end of the opposing surface part 280 and covering the front surface 273 of the displacement member 207. Accordingly, when the detected part 208 begins to enter the detection region, concentration of magnetic field lines can be dispersed between a connection portion of the opposing surface part 280 and the front surface part 281, and an upper edge 281a of the front surface part 281 (achieving an effect similar to that in FIG. 5B). Thus, since a sensor output without an overshoot may be obtained, key press information can be detected with high accuracy.

Further, since the front surface 273 of the displacement member 207 is configured to be covered with the front surface part 281 rising from the opposing surface part 280 of the detected part 208, a wide up-down width of the front surface part 281 can be ensured even if the thickness of the detected part 208 is small. In other words, since an overshoot of the sensor output can be suppressed without using a thick metal plate as in the related art described above, key press information can be detected with high accuracy while suppressing an increase in weight and an increase in cost of the keyboard device 201.

The detected part 208 includes the opposing surface part 280 and the front surface part 281 formed by bending one metal plate, and although not shown, the detected part 208 is not provided on the pair of lateral surfaces (surfaces facing a direction perpendicular to the paper surface in FIG. 14A and FIG. 14B) of the displacement member 207. Accordingly, the detected part 208 can be easily formed by joining (adhering) the bent metal plate to the bottom surface 272 and the front surface 273 of the displacement member 207.

A method for mounting the displacement member 207 to the holder 10 in this embodiment is performed according to the same method as the first embodiment described above. Thus, although not shown, when mounting the displacement member 207 to the holder 10, since the opposing interval between the shaft parts 13 can be widened by bending the mounted part 11 (refer to FIG. 7C), the pair of shaft parts 13 can be easily inserted into the insertion holes 271 of the displacement member 207.

On the other hand, after mounting the displacement member 207 to the holder 10, by fixing the holder 10 to the substrate 9, which has a higher rigidity than the holder 10 (mounted part 11), widening of the opposing interval between the shaft parts 13 of the wall parts 12 (bending of the mounted part 11) can be suppressed. Thus, fall-off of the displacement member 207 from the holder 10 can be suppressed.

Next, referring to FIG. 15A to FIG. 16B, a keyboard device 301 of a third embodiment will be described. In the first embodiment and the second embodiment above, it has been described that the displacement member 7 and 207 is rotated by the hammer 6 or the white key 202a. In the third embodiment, a configuration in which a displacement member 307 is linearly moved will be described. Same portions as in the above embodiments will be labeled with the same reference signs, and descriptions thereof will be omitted.

FIG. 15A is a partially enlarged cross-sectional view of the keyboard device 301 of the third embodiment, and FIG. 15B is a partially enlarged cross-sectional view of the keyboard device 301 taken along a line XVb-XVb in FIG. 15A. FIG. 16A is a partially enlarged cross-sectional view of the keyboard device 301 showing a state in which the white key 2a is pressed from the state in FIG. 15A, and FIG. 16B is a partially enlarged cross-sectional view of the keyboard device 301 showing a state in which the white key 2a is pressed to a terminal position from the state in FIG. 16A. FIG. 15B shows only main parts of the keyboard device 301.

As shown in FIG. 15A, in the keyboard device 301 of the third embodiment, a substrate 9 extending along a vertical direction is fixed to a chassis 4. A coil 90 is printed on a rear surface (a surface on the right side in FIG. 15A) of the substrate 9, and a holder 310 is provided on the upper side of the coil 90.

The holder 310 includes a mounted part 311 in a flat plate shape mounted to the substrate 9, and a retaining part 312 that slidably retains the displacement member 307 on a rear surface of the mounted part 311. The parts 311 and 312 are integrally formed using a resin material (synthetic resin).

A plurality of retaining parts 312 are arranged in the scale direction, and each of the retaining parts 312 includes a pair of overhanging parts 312a (refer to FIG. 15B) that overhang to the rear side from the rear surface of the mounted part 311, and bent parts 312b that bend toward an opposing interval between the pair of overhanging parts 312a.

A pair of guided parts 370 overhang in the scale direction from a front end (end part on the left side in FIG. 15B) of the displacement member 307, and the displacement member 307 is formed in a T-shape in a top view. A T-shaped retaining space in a top view is formed at the retaining part 312 by the overhanging parts 312a and the bent parts 312b. By inserting the displacement member 307 from an opened portion on an upper side (upper side in FIG. 15A) of this retaining space, the displacement member 307 is slidably retained in the retaining part 312.

In the T-shaped retaining space of the retaining part 312, a space that retains the guided parts 370 of the displacement member 307 is closed on a lower end side thereof by a wall (not shown). With the engagement between this wall and the guided parts 370, the displacement member 307 does not fall out downward.

A pair of upper and lower protruding pieces 371 protrude to the rear side from the rear surface of the displacement member 307, and an upper sliding surface 372a and a lower sliding surface 372b of a groove 372 are formed by the pair of protruding pieces 371. The guide pin 65 of the hammer 6 is inserted between the sliding surfaces 372a and 372b.

The upper sliding surface 372a and the lower sliding surface 372b of the groove 372 are formed in parallel (in a straight line shape). In the initial state before the white key 2a is pressed, each sliding surface 372a and 372b of the groove 372 extends to intersect with a displacement trajectory of the guide pin 65 around the rotation shaft 60.

Thus, as shown in FIG. 16A and FIG. 16B, upon rotation of the guide pin 65 around the rotation shaft 60 during key press, the lower sliding surface 372b is pushed downward by the guide pin 65. Accordingly, the displacement member 307 slides and displaces downward along the retaining part 312 of the holder 310. On the other hand, during key release of the white key 2a, with the upper sliding surface 372a pushed upward by the guide pin 65, the displacement member 307 slides and displaces upward along the retaining part 312. Due to the upward and downward sliding displacements of the displacement member 307, the entry amount of the detected part 308 with respect to the detection region increases and decreases.

In this manner, in this embodiment as well, the detected part 308 is configured to be provided at the displacement member 307 which acts in conjunction with the rotation of the white key 2a and the hammer 6. Since the displacement member 307 may be formed to be smaller compared to the white key 2a and the hammer 6, dimensional errors are less likely to occur in each displacement member 307. Furthermore, since the displacement member 307 is configured to be slidably supported on a relatively small holder 310 mounted to the substrate 9 rather than on the chassis 4, mounting errors of each displacement member 307 are also less likely to occur. Accordingly, since a clearance between the coil 90 and the detected part 308 is easily set to a dimension according to a design value at each key 2, key press information of each key 2 can be detected with high accuracy.

Further, as long as the guide pin 65 of the hammer 6 and the groove 372 of the displacement member 307 are configured to be engageable with each other, that is, the displacement member 307 is configured to be slidable in conjunction with the hammer 6, the shape of the displacement member 307 and the like are freely changeable. In other words, by appropriately setting the shape of the displacement member 307 and the like, the arrangement of the coil 90 (substrate 9) may also be changed to a desired position. Thus, design flexibility of the keyboard device 301 is improved.

The detected part 308 includes an opposing surface part 380 covering a front surface of the displacement member 307 opposed to the coil 90, and a bottom surface part 381 connecting to the opposing surface part 380 and covering a bottom surface (outer surface facing a displacement direction front side of the displacement member 307) of the displacement member 307. Accordingly, similar to the above embodiments, a sensor output without an overshoot can be obtained without using a thick metal plate.

Further, the detected part 308 includes the opposing surface part 380 and the bottom surface part 381 formed by bending one metal plate, and although not shown, the detected part 308 is not provided on a pair of lateral surfaces (surfaces facing a direction perpendicular to the paper surface in FIG. 16A and FIG. 16B) of the displacement member 307. Accordingly, the detected part 308 can be easily formed by joining (adhering) the bent metal plate to the bottom surface and the front surface of the displacement member 307.

Although the present invention has been described based on the above embodiments, it is readily understood that the present invention is not limited to these embodiments, and various improvements and modifications may be made within a scope without departing from the spirit of the present invention.

A part or all of each of the above embodiments may be combined with or substituted for a part or all of another embodiment. Thus, for example, the support structure of the white key 202a or the configuration of the detected part 208 of the second embodiment may be applied to the keyboard device 1 of the first embodiment, or the linearly moving displacement member 307 of the third embodiment may be applied to the keyboard device 201 of the second embodiment. Further, as illustrated in FIG. 9A to FIG. 10B as modification examples of the first embodiment, the displacement pattern (sensor output by the coil 90) of the displacement member 207 and 307 may be adjusted by changing the shape of the groove 270 of the displacement member 207 of the second embodiment or the groove 372 of the displacement member 307 of the third embodiment.

In the above embodiments, it has been described that the white key 2a and 202a (key 2 and 202) is rotatably (swingably) supported on the rotation shaft 20 or the shaft parts 213. However, for example, the white key 2a and 202a (key 2 and 202) may also be swingably supported by another known means such as a hinge.

In the above embodiments, the coil 90 has been illustrated as an example of a sensor detecting the key press information of the white key 2a and 202a (key 2 and 202), but the embodiment is not necessarily limited thereto. For example, a sensor that detects key press information based on changes in an electrostatic capacity may also be used, or key press information may also be detected using another known non-contact sensor (e.g., a sensor described in Japanese Patent Application Laid-Open No. H03-048295) or contact sensor (e.g., a switch described in Japanese Patent Application Laid-Open No. 2015-111235).

In the above embodiments, it has been described that the guide pin 65 and 229 is formed on the hammer 6 or white key 202a side, and the groove 70, 270, and 372 is formed on the displacement member 7, 207, and 307 side. However, the groove may also be formed on the hammer 6 or white key 202a side, and the guide pin may also be formed on the displacement member 7, 207, and 307 side.

In the above embodiments, it has been described that a plurality of displacement members 7, 207, and 307 or keys 202 are supported on the holder 10, 210, and 310 extending in the scale direction, but the embodiment is not necessarily limited thereto. For example, one displacement member 7, 207, and 307 may also be supported by one holder 10 and 310, or one white key 202a may also be supported by one holder 210. Further, the hammer 6 may also be supported by a member equivalent to the holder 10, 210, and 310, or, in the case where the keyboard device 1, 201, and 301 is an electronic organ, a pedal keyboard of the electronic organ may also be rotatably supported by a member equivalent to the holder 10, 210, and 310.

In the above embodiments, non-magnetic metal (e.g., copper) has been illustrated as an example of a material of the detected part 8, 208, and 308 which changes the magnetic field of the coil 90. However, the material of the detected part 8, 208, and 308 may also be a metal having magnetic properties or a conductive material other than metal. In other words, the material of the detected part 8, 208, and 308 is not particularly limited as long as it is a conductor that generates eddy currents in response to changes in the magnetic field.

In the above embodiments, although it has been described that the detected part 8, 208, and 308 is provided at the displacement member 7, 207, and 307, the detected part 8, 208, and 308 may also be provided at another rotating member such as the key 2 and 202 or the hammer 6.

In the above embodiments, it has been described that the front surface part 81 and 281 or the bottom surface part 381 of the detected part 8, 208, and 308 is provided on the outer surface facing the displacement direction front side of the displacement member 7, 207, and 307, but the embodiment is not necessarily limited thereto. For example, as in the related art, a portion equivalent to the front surface part 81 and 281 or the bottom surface part 381 may also be provided by joining a thick metal plate to the opposing surface (the surface opposed to the coil 90) of the displacement member 7, 207, and 307. Further, the front surface part 81 and 281 or the bottom surface part 381 of the detected part 8, 208, and 308 may also be omitted, and the detected part 8, 208, and 308 may also be composed of the opposing surface part 80, 280, and 380 only.

In the first embodiment and the second embodiment above, it has been described that the shaft part 13 and 213 is formed on the holder 10 and 210 side, and the insertion hole 71 and 271 into which the shaft part 13 and 213 is inserted is formed on the displacement member 7 and 207 side. However, the shaft part may also be formed on the displacement member 7 and 207 side, and the insertion hole into which the shaft part is inserted may also be formed on the holder 10 and 210 side.

In the first embodiment and the second embodiment above, it has been described that the insertion hole 71 and 271 is a through-hole penetrating the displacement member 7 and 207. However, the insertion hole 71 and 271 may also be a recess (hole) formed on the lateral surface of the displacement member 7 and 207.

In the first embodiment and the second embodiment above, it has been described that partial regions of the outer surfaces 12b and 212b of the wall parts 12 and 212 on the holder 10 and 210 side are linked by the linking part 15 and 215, but the embodiment is not necessarily limited thereto. For example, an entirety from the upper end to the lower end of the outer surfaces 12b and 212b may also be linked by the linking part 15 and 215, or the linking part 15 and 215 may also be omitted.

In the first embodiment above, it has been described that the inclined surfaces 14 and 76c are formed at the guide groove 76 and the shaft part 13, and in the second embodiment, it has been described that the inclined surfaces 224 and 214 are formed at the white key 202a and the shaft part 213. However, these inclined surfaces may also be omitted (e.g., configuring the groove bottom surface 76b of the guide groove 76 as a planar surface).

In the second embodiment and the third embodiment above, it has been described that the detected part 208 and 308 is formed by joining a bent metal plate, but the embodiment is not necessarily limited thereto. For example, the detected part 208 and 308 may also be formed by plating.

In the first embodiment above, it has been described that a thin-walled part (connecting part 11b and 11c and notched part 11g) is formed at the mounted part 11 of the holder 10 and 210. However, these thin-walled parts may also be omitted, and the entire mounted part 11 may also be formed with the same thickness as the base part 11a, or a protrusion (e.g., a rib-shaped protrusion) thicker than the base part 11a may also be formed at the mounted part 11. In other words, as long as the mounted part 11 is capable of being bent, the mounted part 11 is not limited to the above configurations.

In the first embodiment above, it has been described that the front surface 73 and the rear surface 74 of the displacement member 7 are planar surfaces extending in a normal direction from both the front and rear ends of the bottom surface 72. However, the front surface 73 and the rear surface 74 of the displacement member 7 may also be inclined with respect to the normal direction of the bottom surface 72. Further, the front surface 73 and the rear surface 74 of the displacement member 7 may be curved surfaces.

In the first embodiment above, it has been described that the guide groove 76, the protrusions 77a and 77b, and the guide part 78 are formed at the displacement member 7. However, for example, one or more of the configurations among the guide groove 76, the protrusions 77a and 77b, and the guide part 78 may also be omitted. Further, instead of forming the guide part 78 into an arc shape centered on the insertion hole 71, the guide part 78 may also be formed into a straight line shape.

In the first embodiment above, it has been described that an up-down width dimension (height of the rise from the opposing surface part 80) of the front surface part 81 of the detected part 8 is substantially constant, and the upper edge 81a of the front surface part 81 is formed into a straight line shape along the scale direction, but the embodiment is not necessarily limited thereto. For example, unevenness or curved portions may also be present at the upper edge 81a of the front surface part 81 (e.g., the upper edge 81a of the front surface part 81 is mountain-shaped).

In the first embodiment above, it has been described that the opposing surface part 80, the front surface part 81, the rear surface part 82, and the lateral surface part 83 of the detected part 8 are formed by plating, that is, the detected part 8 is formed by applying plating to a part of the displacement member 7. However, for example, the detected part 8 may also be formed by applying plating to the entirety (entire surface) of the displacement member 7. Further, the detected part 8 (opposing surface part 80, front surface part 81, rear surface part 82, and lateral surface part 83) may also be formed by joining a metal plate to the displacement member 7. In the case of this configuration, the detected part 8 may be formed of one metal plate, or the detected part 8 may be formed of a plurality of metal plates.

In the first embodiment above, it has been described that the opposing surface part 80 and the front surface part 81 of the detected part 8 are connected via the curved part 84. However, for example, the curved part 84 may also be omitted (the connection portion between the opposing surface part 80 and the front surface part 81 is angular).

1. A keyboard device comprising:
a first support member;
a plurality of keys swingably supported on the first support member;
a displacement member that displaces in conjunction with swinging of the key or rotation of a hammer accompanying the swinging of the key;
a sensor opposed to a detected part of the displacement member to detect displacement of the displacement member;
a substrate on which the sensor is provided; and
a second support member mounted to the substrate and supporting the displacement member displaceably.

2. The keyboard device according to claim 1, wherein
either one of the displacement member and the key or the hammer comprises a guide pin protruding in a scale direction, and the other of the displacement member and the key or the hammer comprises a groove into which the guide pin is slidably inserted, and
the displacement member displaces by sliding of the guide pin with respect to the groove.

3. The keyboard device according to claim 2, wherein
the displacement member comprises the groove.

4. The keyboard device according to claim 2, wherein
an output of the sensor is capable of being adjusted by changing a shape of the groove.

5. The keyboard device according to claim 1, wherein
a plurality of the displacement members are supported on the second support member extending in a scale direction.

6. The keyboard device according to claim 1, wherein
the displacement member is rotatably supported on the second support member.

7. The keyboard device according to claim 6, wherein
the second support member comprises: a mounted part mounted to the substrate; and a plurality of wall parts that rise from the mounted part to be arranged in a scale direction, and support the displacement member rotatably in an opposing interval between each other, and
the displacement member comprises a guide part protruding from a lateral surface of the displacement member and guiding rotation of the displacement member by contact with the wall part.

8. The keyboard device according to claim 7, wherein
the guide part is formed into an are shape centered on a rotation shaft of the displacement member.

9. A detection method for key press information, which is a detection method for key press information in a keyboard device, the keyboard device comprising:
a first support member;
a plurality of keys swingably supported on the first support member;
a displacement member that displaces in conjunction with swinging of the key or rotation of a hammer accompanying the swinging of the key;
a sensor opposed to a detected part of the displacement member to detect displacement of the displacement member;
a substrate on which the sensor is provided; and
a second support member mounted to the substrate and supporting the displacement member displaceably, the detection method for key press information comprising:
detecting the key press information of the key by causing the detected part to relatively displace with respect to the sensor by the displacement of the displacement member.

10. The detection method for key press information according to claim 9, wherein
either one of the displacement member and the key or the hammer comprises a guide pin protruding in a scale direction, and the other of the displacement member and the key or the hammer comprises a groove into which the guide pin is slidably inserted, and
the displacement member displaces by sliding of the guide pin with respect to the groove.

11. The detection method for key press information according to claim 10, wherein
the displacement member comprises the groove.

12. The detection method for key press information according to claim 10, wherein
an output of the sensor is capable of being adjusted by changing a shape of the groove.

13. The detection method for key press information according to claim 9, wherein
a plurality of the displacement members are supported on the second support member extending in a scale direction.

14. The detection method for key press information according to claim 9, wherein
the displacement member is rotatably supported on the second support member.

15. The detection method for key press information according to claim 14, wherein
the second support member comprises: a mounted part mounted to the substrate; and a plurality of wall parts that rise from the mounted part to be arranged in a scale direction, and support the displacement member rotatably in an opposing interval between each other, and
the displacement member comprises a guide part protruding from a lateral surface of the displacement member and guiding rotation of the displacement member by contact with the wall part.

16. The detection method for key press information according to claim 15, wherein
the guide part is formed into an are shape centered on a rotation shaft of the displacement member.

17. A keyboard device comprising:
a first support member;
a plurality of keys supported on the first support member;
a displacement member that displaces in conjunction with swinging of the key;
a sensor opposed to a detected part of the displacement member to detect displacement of the displacement member;
a substrate on which the sensor is provided;
a second support member mounted to the substrate and supporting the displacement member displaceably; and
a third support member mounted to the first support member and supporting the plurality of keys rotatably.

18. The keyboard device according to claim 17, wherein
the third support member comprises: a mounted part mounted to the first support member; and a plurality of wall parts that rise from the mounted part to be arranged in a scale direction, and support the key rotatably in an opposing interval between each other.

19. The keyboard device according to claim 18, wherein
either one of the displacement member and the key comprises a guide pin protruding in the scale direction, and the other of the displacement member and the key comprises a groove into which the guide pin is slidably inserted, and
the displacement member displaces by sliding of the guide pin with respect to the groove.

20. The keyboard device according to claim 19, wherein
the displacement member comprises the groove.
